(19) United States
(12) Patent Application Publication
(10) Pub. No.: US 2021/0278632 A1
(43) Pub. Date: Sep. 9, 2021

(54) CAMERA LENS ASSEMBLY

(71) Applicant: Zhejiang Sunny Optics Co., Ltd, Yuyao City (CN)

(72) Inventors: Xinquan Wang, Yuyao City (CN); Yunbing Ji, Yuyao City (CN); Fujian Dai, Yuyao City (CN); Liefeng Zhao, Yuyao City (CN)

(21) Appl. No.: 17/160,322

(22) Filed: Jan. 27, 2021

(30) Foreign Application Priority Data
Mar. 3, 2020 (CN) 202010141568.0

(51) Int. Cl. G02B 9/64; G02B 13/00; G02B 27/00

(52) U.S. Cl. CPC G02B 9/64; G02B 27/0025; G02B 13/0045

(57) ABSTRACT

The present disclosure discloses a camera lens assembly including, sequentially from an object side to an image side along an optical axis, a first lens having positive refractive power; a second lens having negative refractive power; a third lens having refractive power; a fourth lens having refractive power; a fifth lens having refractive power; a sixth lens having refractive power; a seventh lens having positive refractive power; and an eighth lens having negative refractive power. A combined focal length f67 of the sixth lens and the seventh lens and a distance BFL along the optical axis from an image-side surface of the eighth lens to an imaging plane of the camera lens assembly satisfy: 7.00<f67/BFL<14.00.

### CROSS-REFERENCE TO RELATED APPLICATION

This application claims benefit of priority to Chinese Patent Application No. 202010141568.0 filed on Mar. 3, 2020 before the China National Intellectual Property Administration, the entire disclosure of which is incorporated herein by reference in its entity.

### TECHNICAL FIELD

The present disclosure relates to the field of optical elements, and specifically, relates to a camera lens assembly.

### BACKGROUND

With the development of science and technology, the electronic product market has an increasing demand for lens assemblies with high pixels that can be applied to the portable electronic product, such as mobile phones. As the thickness of the portable electronic product, such as mobile phones, is reduced, the total length of the lens assembly is limited, thereby increasing the design difficulty for the lens assembly of the portable electronic product, such as mobile phones.

At the same time, with the improvement of the performance and size reduction of the photosensitive Charge-Coupled Device (CCD) and the Complementary Metal-Oxide Semiconductor (CMOS) image sensors, corresponding camera lens assemblies also need to meet the requirements of high image quality. In addition, when designing the lens assembly suitable for the portable electronic product, such as mobile phones, it is also necessary to consider whether it can clear imaging even under insufficient light (such as rainy days, dusk, etc.).

### SUMMARY

The present disclosure provides a camera lens assembly which includes, sequentially from an object side to an image side along an optical axis, a first lens having positive refractive power; a second lens having negative refractive power; a third lens having refractive power; a fourth lens having refractive power; a fifth lens having refractive power; a sixth lens having refractive power; a seventh lens having positive refractive power; and an eighth lens having negative refractive power.

In one embodiment, at least one of an object-side surface of the first lens to an image-side surface of the eighth lens is aspheric.

In one embodiment, half of a diagonal length ImgH of an effective pixel area on an imaging plane of the camera lens assembly may satisfy: 6.00 mm≤ImgH.

In one embodiment, a total effective focal length f of the camera lens assembly and half of a maximal field-of-view Semi-FOV of the camera lens assembly may satisfy: 8.00 mm<f/tan²(Semi-FOV)<9.00 mm.

In one embodiment, a distance TTL along the optical axis from an object-side surface of the first lens to an imaging plane of the camera lens assembly and half of a diagonal length ImgH of an effective pixel area on the imaging plane of the camera lens assembly may satisfy: TTL/ImgH<1.32.

In one embodiment, a total effective focal length f of the camera lens assembly and a radius of curvature R5 of an object-side surface of the third lens may satisfy: 1.00<R5/f<3.50.

In one embodiment, a spaced interval T12 between the first lens and the second lens along the optical axis and a center thickness CT1 of the first lens along the optical axis may satisfy: 13.00<CT1/T12<30.00.

In one embodiment, a radius of curvature R2 of an image-side surface of the first lens and a radius of curvature R3 of an object-side surface of the second lens may satisfy: 1.50<(R2+R3)/(R2−R3)<2.50.

In one embodiment, a combined focal length f67 of the sixth lens and the seventh lens and a distance BFL along the optical axis from an image-side surface of the eighth lens to an imaging plane of the camera lens assembly may satisfy: 7.00<f67/BFL<14.00.

In one embodiment, SAG11, being a distance along the optical axis from an intersection of an object-side surface of the first lens and the optical axis to a vertex of an effective radius of the object-side surface of the first lens, and SAG12, being a distance along the optical axis from an intersection of an image-side surface of the first lens and the optical axis to a vertex of an effective radius of the image-side surface of the first lens, may satisfy: 7.00<SAG11/SAG12<10.00.

In one embodiment, a maximum effective radius DT82 of an image-side surface of the eighth lens and a maximum effective radius DT11 of an object-side surface of the first lens may satisfy: 2.00<(DT82+DT11)/(DT82−DT11)<3.00.

In one embodiment, an edge thickness ET7 of the seventh lens and an edge thickness ET8 of the eighth lens may satisfy: 1.00<ET8/ET7<3.00.

In one embodiment, a combined focal length f23 of the second lens and the third lens and a combined focal length f78 of the seventh lens and the eighth lens may satisfy: 0.50<f78/f23<4.50.

Through the above configuration, the camera lens assembly according to the present disclosure may have at least one beneficial effect, such as ultra-thinness, miniaturization, and high image quality.

### BRIEF DESCRIPTION OF THE DRAWINGS

Other features, objects, and advantages of the present disclosure will become more apparent by reading the detailed description of the non-limiting embodiments with reference to the accompanying drawings:

FIG. 1 illustrates a schematic structural view of a camera lens assembly according to example 1 of the present disclosure;

FIGS. 2A to 2D illustrate a longitudinal aberration curve, an astigmatic curve, a distortion curve, and a lateral color curve of the camera lens assembly of the example 1, respectively;

FIG. 3 illustrates a schematic structural view of a camera lens assembly according to example 2 of the present disclosure;

FIGS. 4A to 4D illustrate a longitudinal aberration curve, an astigmatic curve, a distortion curve, and a lateral color curve of the camera lens assembly of the example 2, respectively;

FIG. 5 illustrates a schematic structural view of a camera lens assembly according to example 3 of the present disclosure;

FIGS. 6A to 6D illustrate a longitudinal aberration curve, an astigmatic curve, a distortion curve, and a lateral color curve of the camera lens assembly of the example 3, respectively;

FIG. 7 illustrates a schematic structural view of a camera lens assembly according to example 4 of the present disclosure;

FIGS. 8A to 8D illustrate a longitudinal aberration curve, an astigmatic curve, a distortion curve, and a lateral color curve of the camera lens assembly of the example 4, respectively;

FIG. 9 illustrates a schematic structural view of a camera lens assembly according to example 5 of the present disclosure;

FIGS. 10A to 10D illustrate a longitudinal aberration curve, an astigmatic curve, a distortion curve, and a lateral color curve of the camera lens assembly of the example 5, respectively;

FIG. 11 illustrates a schematic structural view of a camera lens assembly according to example 6 of the present disclosure;

FIGS. 12A to 12D illustrate a longitudinal aberration curve, an astigmatic curve, a distortion curve, and a lateral color curve of the camera lens assembly of the example 6, respectively;

FIG. 13 illustrates a schematic structural view of a camera lens assembly according to example 7 of the present disclosure;

FIGS. 14A to 14D illustrate a longitudinal aberration curve, an astigmatic curve, a distortion curve, and a lateral color curve of the camera lens assembly of the example 7, respectively;

FIG. 15 illustrates a schematic structural view of a camera lens assembly according to example 8 of the present disclosure;

FIGS. 16A to 16D illustrate a longitudinal aberration curve, an astigmatic curve, a distortion curve, and a lateral color curve of the camera lens assembly of the example 8, respectively;

FIG. 17 illustrates a schematic structural view of a camera lens assembly according to example 9 of the present disclosure; and

FIGS. 18A to 18D illustrate a longitudinal aberration curve, an astigmatic curve, a distortion curve, and a lateral color curve of the camera lens assembly of the example 9, respectively.

### DETAILED DESCRIPTION OF EMBODIMENTS

For a better understanding of the present disclosure, various aspects of the present disclosure will be described in more detail with reference to the accompanying drawings. It should be understood that the detailed description is merely illustrative of the exemplary embodiments of the present disclosure and is not intended to limit the scope of the present disclosure in any way. Throughout the specification, the same reference numerals refer to the same elements. The expression “and/or” includes any and all combinations of one or more of the associated listed items.

It should be noted that in the present specification, the expressions such as first, second, third are used merely for distinguishing one feature from another, without indicating any limitation on the features. Thus, a first lens discussed below may also be referred to as a second lens or a third lens without departing from the teachings of the present disclosure.

In the accompanying drawings, the thickness, size and shape of the lens have been somewhat exaggerated for the convenience of explanation. In particular, shapes of spherical surfaces or aspheric surfaces shown in the accompanying drawings are shown by way of example. That is, shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, the paraxial area refers to an area near the optical axis. If a surface of a lens is convex and the position of the convex is not defined, it indicates that the surface of the lens is convex at least in the paraxial region; and if a surface of a lens is concave and the position of the concave is not defined, it indicates that the surface of the lens is concave at least in the paraxial region. In each lens, the surface closest to the object is referred to as an object-side surface of the lens, and the surface closest to the imaging plane is referred to as an image-side surface of the lens.

It should be further understood that the terms “comprising,” “including,” “having,” “containing” and/or “contain,” when used in the specification, specify the presence of stated features, elements and/or components, but do not exclude the presence or addition of one or more other features, elements, components and/or combinations thereof. In addition, expressions, such as “at least one of,” when preceding a list of features, modify the entire list of features rather than an individual element in the list. Further, the use of “may,” when describing embodiments of the present disclosure, refers to “one or more embodiments of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It will be further understood that terms, such as those defined in commonly used dictionaries, should be interpreted as having a meaning that is consistent with the meaning in the context of the relevant art and will not be interpreted in an idealized or overly formal sense, unless expressly so defined herein.

It should also be noted that, the examples in the present disclosure and the features in the examples may be combined with each other on a non-conflict basis. The present disclosure will be described in detail below with reference to the accompanying drawings and in combination with the examples.

The features, principles, and other aspects of the present disclosure are described in detail below.

A camera lens assembly according to an exemplary embodiment of the present disclosure may include eight lenses having refractive power, which are a first lens, a second lens, a third lens, a fourth lens, a fifth lens, a sixth lens, a seventh lens and an eighth lens. The eight lenses are arranged sequentially from an object side to an image side along an optical axis. Among the first lens to the eighth lens, there may be a spaced interval between each two adjacent lenses.

In an exemplary embodiment, the first lens may have positive refractive power; the second lens may have negative refractive power; the third lens may have positive or negative refractive power; the fourth lens may have positive or negative refractive power; the fifth lens may have positive or negative refractive power; the sixth lens may have positive or negative refractive power; the seventh lens may have positive refractive power; and the eighth lens may have negative refractive power.

In an exemplary embodiment, the camera lens assembly according to the present disclosure may satisfy: 6.00 mm≤ImgH, where ImgH is half of a diagonal length of an effective pixel area on an imaging plane of the camera lens assembly. Satisfying 6.00 mm≤ImgH is beneficial to achieving the characteristics of a large imaging plane.

In an exemplary embodiment, the camera lens assembly according to the present disclosure may satisfy: 8.00 mm<f/tan²(Semi-FOV)<9.00 mm, where f is a total effective focal length of the camera lens assembly, and Semi-FOV is half of a maximal field-of-view of the camera lens assembly. When 8.00 mm<f/tan²(Semi-FOV)<9.00 mm is satisfied, the camera lens assembly may have the characteristics of high pixels and ultra-thin. At the same time, the aberrations of the camera lens assembly may be better compensated.

In an exemplary embodiment, the camera lens assembly according to the present disclosure may satisfy: TTL/ImgH<1.32, where TTL is a distance along the optical axis from an object-side surface of the first lens to an imaging plane of the camera lens assembly, and ImgH is half of a diagonal length of an effective pixel area on the imaging plane of the camera lens assembly. Satisfying TTL/ImgH<1.32 may ensure the camera lens assembly have better image quality under the premise of ensuring the total length of the camera lens assembly being thin, thereby reducing the design difficulty.

In an exemplary embodiment, the camera lens assembly according to the present disclosure may satisfy: 1.00<R5/f<3.50, where f is a total effective focal length of the camera lens assembly, and R5 is a radius of curvature of an object-side surface of the third lens. More specifically, R5 and f may further satisfy: 1.10<R5/f<3.20. When 1.00<R5/f<3.50 is satisfied, the field curvature and distortion of the camera lens assembly may be reduced, and the processing difficulty of the third lens may be controlled at the same time.

In an exemplary embodiment, the camera lens assembly according to the present disclosure may satisfy: 13.00<CT1/T12<30.00, where T12 is a spaced interval between the first lens and the second lens along the optical axis, and CT1 is a center thickness of the first lens along the optical axis. When 13.00<CT1/T12<30.00 is satisfied, it is beneficial to reduce the amount of deformation caused by assembly the lens and reduce the difficulty of assembly, thereby obtaining better image quality.

In an exemplary embodiment, the camera lens assembly according to the present disclosure may satisfy: 1.50<(R2+R3)/(R2−R3)<2.50, where R2 is a radius of curvature of an image-side surface of the first lens, and R3 is a radius of curvature of an object-side surface of the second lens. More specifically, R2 and R3 may further satisfy: 1.90<(R2+R3)/(R2−R3)<2.30. When 1.50<(R2+R3)/(R2−R3)<2.50 is satisfied, the deflection angle at the edge field-of-view on the object-side surface of the first lens may be reasonably controlled within a reasonable range, and the sensitivity of the camera lens assembly may be effectively reduced.

In an exemplary embodiment, the camera lens assembly according to the present disclosure may satisfy: 7.00<f67/BFL<14.00, where f67 is a combined focal length of the sixth lens and the seventh lens, and BFL is a distance along the optical axis from an image-side surface of the eighth lens to an imaging plane of the camera lens assembly. More specifically, f67 and BFL may further satisfy: 7.30<f67/BFL<13.50. When 7.00<f67/BFL<14.00 is satisfied, it is beneficial to correct the chromatic aberration of the camera lens assembly, and correct the field curvature of the camera lens assembly at the same time, so as to improve the image quality of the camera lens assembly.

In an exemplary embodiment, the camera lens assembly according to the present disclosure may satisfy: 7.00<SAG11/SAG12<10.00, where SAG11 is a distance along the optical axis from an intersection of an object-side surface of the first lens and the optical axis to a vertex of an effective radius of the object-side surface of the first lens, and SAG12 is a distance along the optical axis from an intersection of an image-side surface of the first lens and the optical axis to a vertex of an effective radius of the image-side surface of the first lens. More specifically, SAG11 and SAG12 may further satisfy: 7.70<SAG11/SAG12<9.50. Satisfying 7.00<SAG11/SAG12<10.00 may avoid excessive bending of the first lens to reduce processing difficulty, and at the same time make the assembly of the camera lens assembly more stable.

In an exemplary embodiment, the camera lens assembly according to the present disclosure may satisfy: 2.00<(DT82+DT11)/(DT82-DT11)<3.00, where DT82 is a maximum effective radius of an image-side surface of the eighth lens, and DT11 is a maximum effective radius of an object-side surface of the first lens. More specifically, DT82 and DT11 may further satisfy: 2.40<(DT82+DT11)/(DT82-DT11)<2.70. Satisfying 2.00<(DT82+DT11)/(DT82-DT11)<3.00 may prevent the diameter difference between the lenses from being too large, and reduce the difficulty of assembly, so as to ensure the MTF performance after assembly.

In an exemplary embodiment, the camera lens assembly according to the present disclosure may satisfy: 1.00<ET8/ET7<3.00, where ET7 is an edge thickness of the seventh lens, and ET8 is an edge thickness of the eighth lens. More specifically, ET8 and ET7 may further satisfy: 1.20<ET8/ET7<2.70. When 1.00<ET8/ET7<3.00 is satisfied, the aberration may be effectively controlled, so that the camera lens assembly may obtain better image quality. Also, it is more conducive to the stability of the lens assembly and the miniaturization of the lens assembly.

In an exemplary embodiment, the camera lens assembly according to the present disclosure may satisfy: 0.50<f78/f23<4.50, where f23 is a combined focal length of the second lens and the third lens, and f78 is a combined focal length of the seventh lens and the eighth lens. More specifically, f78 and f23 may further satisfy: 0.90<f78/f23<4.40. Satisfying 0.50<f78/f23<4.50 is beneficial to better compensating the aberrations of the camera lens assembly. At the same time, it is beneficial to improve the resolution of the camera lens assembly.

In an exemplary embodiment, the camera lens assembly according to the present disclosure further includes a stop disposed between the object side and the object-side surface of the first lens or disposed between the first lens and the second lens. Optionally, the above camera lens assembly may further include an optical filter for correcting the color deviation and/or a protective glass for protecting the photosensitive element located on an imaging plane.

The camera lens assembly according to the above embodiments of the present disclosure may employ a plurality of lenses, such as eight lenses as described above. By properly configuring the refractive power of each lens, the surface shape, the center thickness of each lens, and spaced intervals along the optical axis between the lenses, the size of the camera lens assembly may be effectively reduced, and the workability of the camera lens assembly may be improved, such that the camera lens assembly is more advantageous for production processing and may be applied to portable electronic products. The camera lens assembly configured as described above may have characteristics such as large aperture, large imaging plane, ultra-thin, and good image quality.

In the embodiments of the present disclosure, at least one of the surfaces of lenses is aspheric, that is, at least one of the object-side surface of the first lens to the image-side surface of the eighth lens is aspheric. The aspheric lens is characterized by a continuous change in curvature from the center of the lens to the periphery of the lens. Unlike a spherical lens having a constant curvature from the center of the lens to the periphery of the lens, the aspheric lens has a better curvature radius characteristic, and has the advantages of improving distortion aberration and improving astigmatic aberration. With aspheric lens, the aberrations that occur during imaging may be eliminated as much as possible, and thus improving the image quality. Optionally, at least one of the object-side surface and the image-side surface of each of the first lens, the second lens, the third lens, the fourth lens, the fifth lens, the sixth lens, the seventh lens and the eighth lens is aspheric. Optionally, the object-side surface and the image-side surface of each of the first lens, the second lens, the third lens, the fourth lens, the fifth lens, the sixth lens, the seventh lens and the eighth lens are aspheric.

However, it will be understood by those skilled in the art that the number of lenses constituting the camera lens assembly may be varied to achieve the various results and advantages described in this specification without departing from the technical solution claimed by the present disclosure. For example, although the embodiment is described by taking eight lenses as an example, the camera lens assembly is not limited to include eight lenses. The camera lens assembly may also include other numbers of lenses if desired.

Some specific examples of a camera lens assembly applicable to the above embodiment will be further described below with reference to the accompanying drawings.

### Example 1

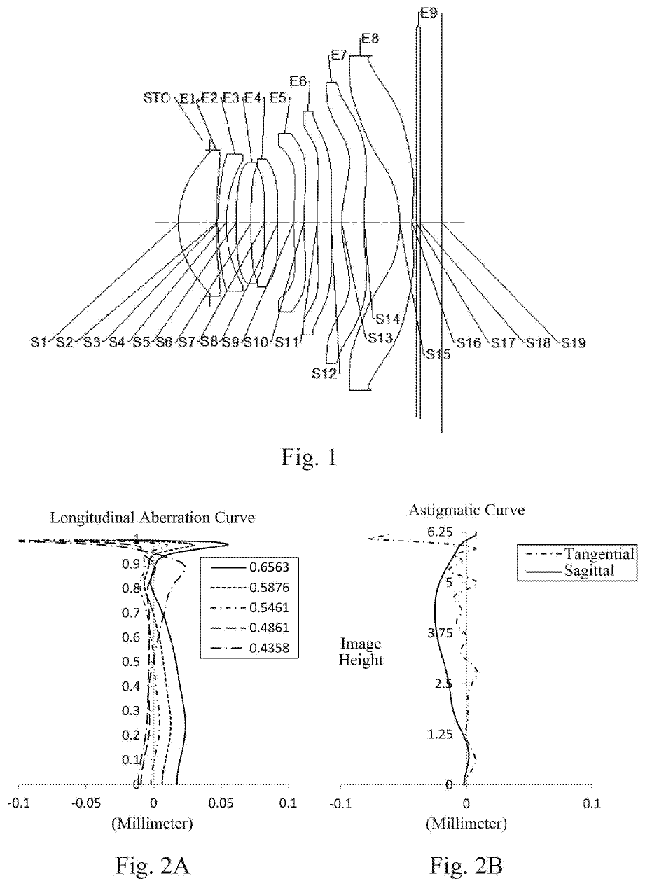

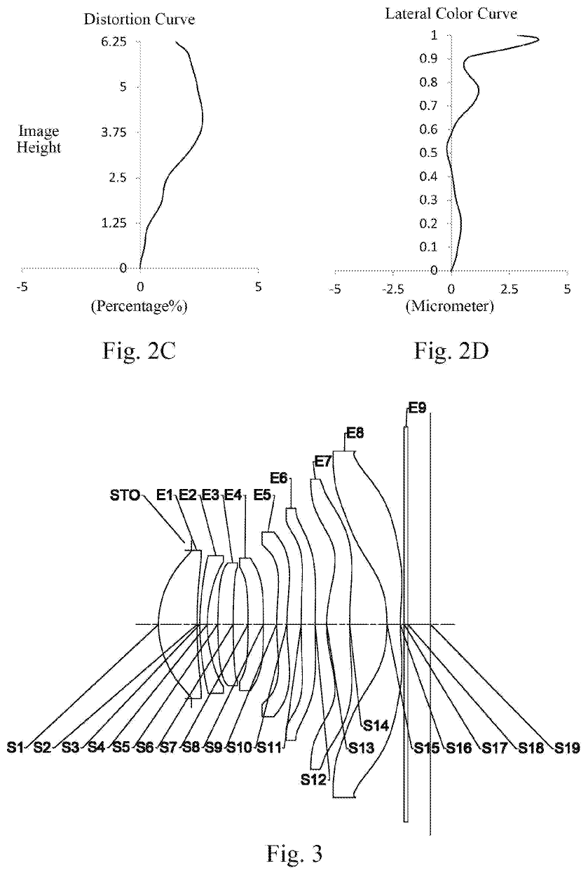

A camera lens assembly according to example 1 of the present disclosure is described below with reference to FIG. 1 to FIG. 2D. FIG. 1 shows a schematic structural view of the camera lens assembly according to example 1 of the present disclosure.

As shown in FIG. 1, the camera lens assembly includes a stop STO, a first lens E1, a second lens E2, a third lens E3, a fourth lens E4, a fifth lens E5, a sixth lens E6, a seventh lens E7, an eighth lens E8, an optical filter E9 and an imaging plane S19, which are sequentially arranged from an object side to an image side.

The first lens E1 has positive refractive power, an object-side surface S1 thereof is convex, and an image-side surface S2 thereof is concave. The second lens E2 has negative refractive power, an object-side surface S3 thereof is convex, and an image-side surface S4 thereof is concave. The third lens E3 has positive refractive power, an object-side surface S5 thereof is convex, and an image-side surface S6 thereof is concave. The fourth lens E4 has positive refractive power, an object-side surface S7 thereof is convex, and an image-side surface S8 thereof is convex. The fifth lens E5 has negative refractive power, an object-side surface S9 thereof is convex, and an image-side surface S10 thereof is concave. The sixth lens E6 has positive refractive power, an object-side surface S11 thereof is convex, and an image-side surface S12 thereof is concave. The seventh lens E7 has positive refractive power, an object-side surface S13 thereof is convex, and an image-side surface S14 thereof is concave. The eighth lens E8 has negative refractive power, an object-side surface S15 thereof is concave, and an image-side surface S16 thereof is concave. The optical filter E9 has an object-side surface S17 and an image-side surface S18. Light from an object sequentially passes through the respective surfaces S1 to S18 and is finally imaged on the imaging plane S19.

Table 1 is a table illustrating basic parameters of the camera lens assembly of example 1, wherein the units for the radius of curvature, the thickness/distance and the focal length are millimeter (mm).

TABLE 1

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.9475 | | | | |
| S1 | Aspheric | 2.7132 | 1.1272 | 1.55 | 56.1 | 5.77 | −0.3796 |
| S2 | Aspheric | 16.6158 | 0.0400 | | | | 0.0000 |
| S3 | Aspheric | 6.4916 | 0.2500 | 1.68 | 19.2 | −11.12 | 6.5229 |
| S4 | Aspheric | 3.4380 | 0.2954 | | | | −0.3292 |
| S5 | Aspheric | 9.2224 | 0.4566 | 1.57 | 37.3 | 35.83 | 0.0000 |
| S6 | Aspheric | 16.4844 | 0.3923 | | | | 0.0000 |
| S7 | Aspheric | 77.4368 | 0.4063 | 1.64 | 23.4 | 98.00 | 0.0000 |
| S8 | Aspheric | −333.8697 | 0.4664 | | | | 0.0000 |
| S9 | Aspheric | 7.2943 | 0.3000 | 1.68 | 19.2 | −120.08 | 0.0000 |
| S10 | Aspheric | 6.5843 | 0.4031 | | | | −16.8185 |
| S11 | Aspheric | 29.7955 | 0.4099 | 1.57 | 37.3 | 383.24 | −31.4547 |
| S12 | Aspheric | 34.3171 | 0.3248 | | | | 0.0000 |
| S13 | Aspheric | 4.3217 | 0.6653 | 1.55 | 56.1 | 9.68 | 0.0000 |
| S14 | Aspheric | 22.3417 | 1.0612 | | | | 26.6548 |
| S15 | Aspheric | −5.0967 | 0.3800 | 1.54 | 55.9 | −4.93 | −2.0394 |
| S16 | Aspheric | 5.6515 | 0.1191 | | | | −0.0149 |
| S17 | Spherical | Infinite | 0.1100 | 1.52 | 64.2 | | |
| S18 | Spherical | Infinite | 0.6538 | | | | |
| S19 | Spherical | Infinite | | | | | |

In this example, a total effective focal length f of the camera lens assembly is 6.72 mm, a total length TTL of the camera lens assembly (that is, a distance along the optical axis from the object-side surface S1 of the first lens E1 to the imaging surface S19 of the camera lens assembly) is 7.86 mm, half of a diagonal length ImgH of an effective pixel area on the imaging plane S19 of the camera lens assembly is 6.26 mm, half of a maximal field-of-view Semi-FOV of the camera lens assembly is 42.16°, and an aperture value Fno of the camera lens assembly is 1.59.

In example 1, the object-side surface and the image-side surface of any one of the first lens E1 to the eighth lens E8 are aspheric. The surface shape x of each aspheric lens may be defined by using, but not limited to, the following aspheric formula:

$$x = \frac{c {h}^{2}}{1 + \sqrt{1 - ( k + 1 ) {c}^{2} {h}^{2}}} + \sum A i {h}^{i} \qquad ( 1 )$$

Where, x is the sag—the axis-component of the displacement of the surface from the aspheric vertex, when the surface is at height h from the optical axis; c is a paraxial curvature of the aspheric surface, c=1/R (that is, the paraxial curvature c is reciprocal of the radius of curvature R in the above Table 1); k is a conic coefficient; Ai is a correction coefficient for the i-th order of the aspheric surface. Table 2 below shows high-order coefficients A4, A6, A8, A10, A12, A14, A16, A18 and A20 applicable to each aspheric surface S1 to S16 in example 1.

TABLE 2

| Surface | | | | | |
|---|---|---|---|---|---|
| number | A4 | A6 | A8 | A10 | A12 |
| S1 | 1.9763E−03 | 4.2333E−04 | 3.2823E−04 | −7.9955E−04 | 6.6522E−04 |
| S2 | 1.0274E−02 | −1.4695E−02 | 1.6018E−02 | −1.2211E−02 | 6.2170E−03 |
| S3 | −9.1102E−03 | −1.0364E−02 | 1.5960E−02 | −1.3526E−02 | 7.2124E−03 |
| S4 | −1.3059E−02 | 1.1293E−03 | 4.7854E−03 | −5.9018E−03 | 3.8793E−03 |
| S5 | −1.1406E−03 | 4.9309E−03 | −9.1894E−03 | 1.3010E−02 | −1.0771E−02 |
| S6 | −3.5238E−03 | −1.4093E−03 | 1.1615E−02 | −2.2165E−02 | 2.6160E−02 |
| S7 | −2.0605E−02 | −7.6744E−03 | 1.6663E−02 | −2.6025E−02 | 2.3539E−02 |
| S8 | −2.2267E−02 | −1.1284E−03 | 2.3811E−03 | −4.1799E−03 | 3.2741E−03 |
| S9 | −2.5241E−02 | −5.4247E−03 | 7.2943E−03 | −4.7031E−03 | 1.8986E−03 |
| S10 | −7.3415E−03 | −1.4514E−02 | 1.1078E−02 | −4.8086E−03 | 1.2782E−03 |
| S11 | 2.7895E−02 | −2.7962E−02 | 1.2393E−02 | −2.9914E−03 | 2.2678E−04 |
| S12 | 2.2560E−02 | −3.3100E−02 | 1.6699E−02 | −4.7717E−03 | 7.5294E−04 |
| S13 | 8.2123E−03 | −1.7474E−02 | 7.4581E−03 | −4.0032E−03 | 1.9580E−03 |
| S14 | 1.8646E−02 | −6.3794E−03 | −5.4766E−04 | −8.6513E−04 | 9.7694E−04 |
| S15 | −8.9998E−02 | 8.3737E−02 | −5.3616E−02 | 2.1038E−02 | −5.2399E−03 |
| S16 | −9.7896E−02 | 6.7449E−02 | −3.3329E−02 | 1.0627E−02 | −2.2553E−03 |

| Surface | | | | |
|---|---|---|---|---|
| number | A14 | A16 | A18 | A20 |
| S1 | −2.9193E−04 | 7.1012E−05 | −9.0738E−06 | 4.6512E−07 |
| S2 | −2.0892E−03 | 4.5689E−04 | −6.3045E−05 | 5.0285E−06 |
| S3 | −2.3813E−03 | 4.6877E−04 | −5.0412E−05 | 2.2918E−06 |
| S4 | −1.4717E−03 | 3.4918E−04 | −5.1105E−05 | 3.4973E−06 |
| S5 | 5.5394E−03 | −1.6598E−03 | 2.6650E−04 | −1.7771E−05 |
| S6 | −1.9271E−02 | 9.0052E−03 | −2.5704E−03 | 4.0682E−04 |
| S7 | −1.3079E−02 | 4.4005E−03 | −8.2329E−04 | 6.5796E−05 |
| S8 | −1.5280E−03 | 4.4316E−04 | −7.4112E−05 | 5.4972E−06 |
| S9 | −5.3522E−04 | 1.0404E−04 | −1.2411E−05 | 6.6256E−07 |
| S10 | −2.0629E−04 | 1.9111E−05 | −8.8999E−07 | 1.4429E−08 |
| S11 | 6.8456E−05 | −2.1716E−05 | 2.6873E−06 | −1.6129E−07 |
| S12 | −3.5171E−05 | −1.1330E−05 | 2.8890E−06 | −3.3833E−07 |
| S13 | −6.4661E−04 | 1.4018E−04 | −2.0475E−05 | 2.0566E−06 |
| S14 | −3.7191E−04 | 7.9308E−05 | −1.0847E−05 | 1.0026E−06 |
| S15 | 8.7598E−04 | −1.0207E−04 | 8.4586E−06 | −5.0104E−07 |
| S16 | 3.3198E−04 | −3.4884E−05 | 2.6568E−06 | −1.4707E−07 |

FIG. 2A illustrates a longitudinal aberration curve of the camera lens assembly according to example 1, representing deviations of focal points converged by light of different wavelengths after passing through the lens assembly. FIG. 2B illustrates an astigmatic curve of the camera lens assembly according to example 1, representing a curvature of a tangential plane and a curvature of a sagittal plane. FIG. 2C illustrates a distortion curve of the camera lens assembly according to example 1, representing amounts of distortion corresponding to different image heights. FIG. 2D illustrates a lateral color curve of the camera lens assembly according to example 1, representing deviations of different image heights on an imaging plane after light passes through the lens assembly. It can be seen from FIG. 2A to FIG. 2D that the camera lens assembly provided in example 1 may achieve good image quality.

### Example 2

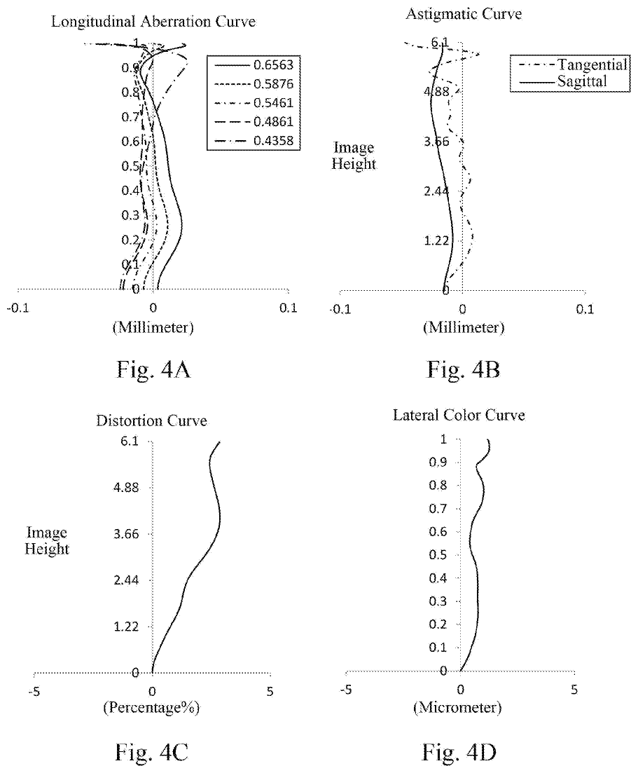

A camera lens assembly according to example 2 of the present disclosure is described below with reference to FIG. 3 to FIG. 4D. In this example and the following examples, for the purpose of brevity, the description of parts similar to those in example 1 will be omitted. FIG. 3 shows a schematic structural view of the camera lens assembly according to example 2 of the present disclosure.

As shown in FIG. 3, the camera lens assembly includes a stop STO, a first lens E1, a second lens E2, a third lens E3, a fourth lens E4, a fifth lens E5, a sixth lens E6, a seventh lens E7, an eighth lens E8, an optical filter E9 and an imaging plane S19, which are sequentially arranged from an object side to an image side.

The first lens E1 has positive refractive power, an object-side surface S1 thereof is convex, and an image-side surface S2 thereof is concave. The second lens E2 has negative refractive power, an object-side surface S3 thereof is convex, and an image-side surface S4 thereof is concave. The third lens E3 has positive refractive power, an object-side surface S5 thereof is convex, and an image-side surface S6 thereof is concave. The fourth lens E4 has negative refractive power, an object-side surface S7 thereof is concave, and an image-side surface S8 thereof is convex. The fifth lens E5 has positive refractive power, an object-side surface S9 thereof is convex, and an image-side surface S10 thereof is concave. The sixth lens E6 has negative refractive power, an object-side surface S11 thereof is convex, and an image-side surface S12 thereof is convex. The seventh lens E7 has positive refractive power, an object-side surface S13 thereof is convex, and an image-side surface S14 thereof is concave. The eighth lens E8 has negative refractive power, an object-side surface S15 thereof is concave, and an image-side surface S16 thereof is concave. The optical filter E9 has an object-side surface S17 and an image-side surface S18. Light from an object sequentially passes through the respective surfaces S1 to S18 and is finally imaged on the imaging plane S19.

In this example, a total effective focal length f of the camera lens assembly is 6.62 mm, a total length TTL of the camera lens assembly is 7.86 mm, half of a diagonal length ImgH of an effective pixel area on the imaging plane S19 of the camera lens assembly is 6.10 mm, half of a maximal field-of-view Semi-FOV of the camera lens assembly is 41.36°, and an aperture value Fno of the camera lens assembly is 1.55.

Table 3 is a table illustrating basic parameters of the camera lens assembly of example 2, wherein the units for the radius of curvature, the thickness/distance and the focal length are millimeter (mm). Table 4 shows high-order coefficients applicable to each aspheric surface in example 2, wherein the surface shape of each aspheric surface may be defined by the formula (1) given in the above example 1.

TABLE 3

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.9556 | | | | |
| S1 | Aspheric | 2.7185 | 1.1164 | 1.55 | 56.1 | 5.71 | −0.3429 |
| S2 | Aspheric | 18.0986 | 0.0736 | | | | 0.0000 |
| S3 | Aspheric | 6.5254 | 0.2200 | 1.68 | 19.2 | −11.36 | 6.4785 |
| S4 | Aspheric | 3.4876 | 0.2982 | | | | −0.2877 |
| S5 | Aspheric | 9.7508 | 0.4464 | 1.57 | 37.3 | 34.22 | 0.0000 |
| S6 | Aspheric | 19.1303 | 0.4356 | | | | 0.0000 |
| S7 | Aspheric | −45.7624 | 0.4400 | 1.64 | 23.4 | −499.90 | 0.0000 |
| S8 | Aspheric | −53.5765 | 0.3853 | | | | 0.0000 |
| S9 | Aspheric | 6.9263 | 0.2975 | 1.68 | 19.2 | 2356.05 | 0.0000 |
| S10 | Aspheric | 6.8355 | 0.4084 | | | | −13.4869 |
| S11 | Aspheric | 34.4782 | 0.4050 | 1.57 | 37.3 | −165.62 | −5.7206 |
| S12 | Aspheric | 25.1612 | 0.3336 | | | | 0.0000 |
| S13 | Aspheric | 3.9329 | 0.6638 | 1.55 | 56.1 | 8.62 | −1.0000 |
| S14 | Aspheric | 22.3315 | 1.0822 | | | | 26.6726 |
| S15 | Aspheric | −5.0988 | 0.3800 | 1.54 | 55.9 | −4.92 | −1.9810 |
| S16 | Aspheric | 5.6271 | 0.1133 | | | | −0.0283 |
| S17 | Spherical | Infinite | 0.1100 | 1.52 | 64.2 | | |
| S18 | Spherical | Infinite | 0.6504 | | | | |
| S19 | Spherical | Infinite | | | | | |

TABLE 4

| Surface | | | | | |
|---|---|---|---|---|---|
| number | A4 | A6 | A8 | A10 | A12 |
| S1 | 1.3703E−03 | 2.0261E−03 | −2.1114E−03 | 1.4257E−03 | −5.8666E−04 |
| S2 | 1.0997E−02 | −1.4641E−02 | 1.5777E−02 | −1.2626E−02 | 7.2340E−03 |
| S3 | −7.8383E−03 | −1.1654E−02 | 1.4853E−02 | −1.0490E−02 | 4.8550E−03 |
| S4 | −1.1493E−02 | −2.8137E−03 | 8.2749E−03 | −7.7274E−03 | 5.1987E−03 |
| S5 | 5.3103E−04 | −1.0931E−03 | 3.4367E−03 | −4.8448E−03 | 5.1787E−03 |
| S6 | −3.6905E−03 | 5.8783E−03 | −1.1359E−02 | 1.6909E−02 | −1.5503E−02 |
| S7 | −2.5466E−02 | 1.1662E−02 | −2.4107E−02 | 2.7509E−02 | −2.1157E−02 |
| S8 | −2.5674E−02 | 2.5664E−03 | 2.6272E−04 | −4.3840E−03 | 4.5275E−03 |
| S9 | −2.3038E−02 | −6.1844E−03 | 6.2091E−03 | −3.3578E−03 | 1.1536E−03 |
| S10 | −3.3023E−03 | −1.7738E−02 | 1.2735E−02 | −5.4481E−03 | 1.4590E−03 |
| S11 | 2.5758E−02 | −2.8070E−02 | 1.4398E−02 | −4.5288E−03 | 8.1064E−04 |
| S12 | 1.1971E−02 | −2.9810E−02 | 1.7535E−02 | −5.6591E−03 | 9.8896E−04 |
| S13 | 4.3119E−03 | −1.7870E−02 | 8.6835E−03 | −4.0983E−03 | 1.7297E−03 |
| S14 | 2.0101E−02 | −9.7103E−03 | 2.4011E−04 | 2.2360E−05 | 3.0630E−04 |
| S15 | −5.7867E−02 | 3.4813E−02 | −1.9943E−02 | 7.6624E−03 | −1.8349E−03 |
| S16 | −6.3617E−02 | 2.9941E−02 | −1.2883E−02 | 3.9152E−03 | −8.0258E−04 |

| Surface | | | | |
|---|---|---|---|---|
| number | A14 | A16 | A18 | A20 |
| S1 | 1.4879E−04 | −2.3109E−05 | 2.0884E−06 | −9.8799E−08 |
| S2 | −2.9041E−03 | 7.8941E−04 | −1.3755E−04 | 1.3777E−05 |
| S3 | −1.4758E−03 | 2.8376E−04 | −3.1726E−05 | 1.6061E−06 |
| S4 | −2.5472E−03 | 8.5870E−04 | −1.6873E−04 | 1.3947E−05 |
| S5 | −3.2692E−03 | 1.2414E−03 | −2.5348E−04 | 2.1150E−05 |
| S6 | 9.4861E−03 | −3.8120E−03 | 9.7988E−04 | −1.4705E−04 |
| S7 | 1.0592E−02 | −3.2888E−03 | 5.7260E−04 | −4.2627E−05 |
| S8 | −2.3894E−03 | 7.2616E−04 | −1.2081E−04 | 8.5823E−06 |
| S9 | −2.9050E−04 | 53612E−05 | −7.0948E−06 | 4.1428E−07 |
| S10 | −24127E−04 | 2.3281E−05 | −1.1575E−06 | 2.1374E−08 |
| S11 | −6.2207E−05 | −3.7325E−06 | 1.1876E−06 | −9.1640E−08 |
| S12 | −4.7988E−05 | −1.8246E−05 | 4.7819E−06 | −5.7063E−07 |
| S13 | −5.3088E−04 | 1.1117E−04 | −1.5925E−05 | 1.5774E−06 |
| S14 | −1.5224E−04 | 3.6090E−05 | −5.2348E−06 | 5.0393E−07 |
| S15 | 2.8670E−04 | −3.0309E−05 | 2.1963E−06 | −1.0762E−07 |
| S16 | 1.1359E−04 | −1.1396E−05 | 8.2332E−07 | −4.2990E−08 |

FIG. 4A illustrates a longitudinal aberration curve of the camera lens assembly according to example 2, representing deviations of focal points converged by light of different wavelengths after passing through the lens assembly. FIG. 4B illustrates an astigmatic curve of the camera lens assembly according to example 2, representing a curvature of a tangential plane and a curvature of a sagittal plane. FIG. 4C illustrates a distortion curve of the camera lens assembly according to example 2, representing amounts of distortion corresponding to different image heights. FIG. 4D illustrates a lateral color curve of the camera lens assembly according to example 2, representing deviations of different image heights on an imaging plane after light passes through the lens assembly. It can be seen from FIG. 4A to FIG. 4D that the camera lens assembly provided in example 2 may achieve good image quality.

### Example 3

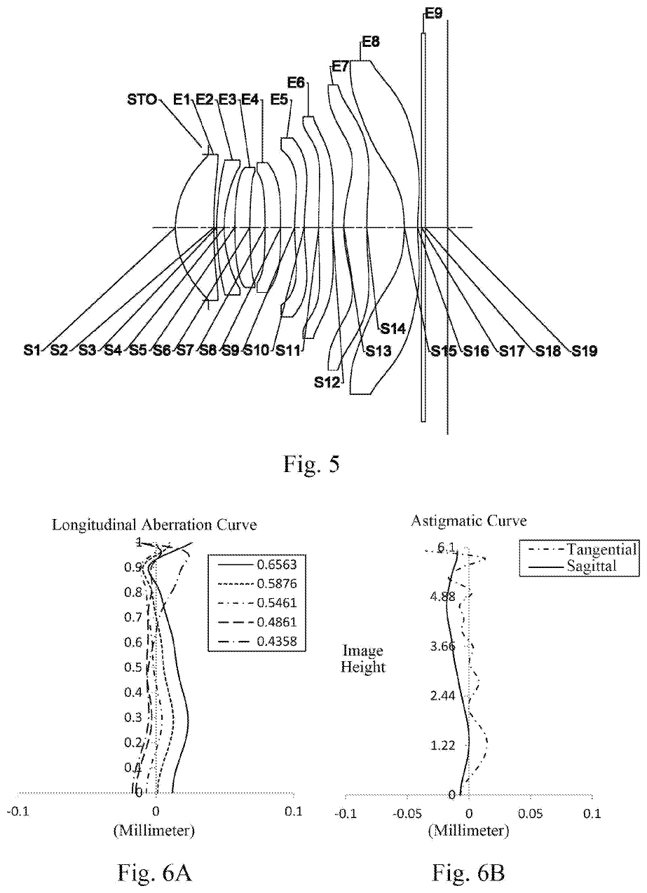

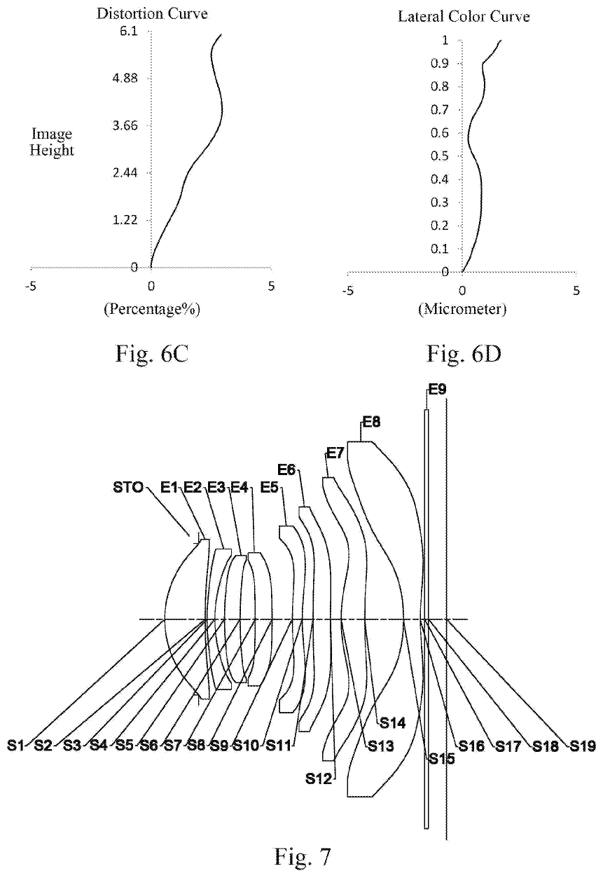

A camera lens assembly according to example 3 of the present disclosure is described below with reference to FIG. 5 to FIG. 6D. FIG. 5 shows a schematic structural view of the camera lens assembly according to example 3 of the present disclosure.

As shown in FIG. 5, the camera lens assembly includes a stop STO, a first lens E1, a second lens E2, a third lens E3, a fourth lens E4, a fifth lens E5, a sixth lens E6, a seventh lens E7, an eighth lens E8, an optical filter E9 and an imaging plane S19, which are sequentially arranged from an object side to an image side.

The first lens E1 has positive refractive power, an object-side surface S1 thereof is convex, and an image-side surface S2 thereof is concave. The second lens E2 has negative refractive power, an object-side surface S3 thereof is convex, and an image-side surface S4 thereof is concave. The third lens E3 has positive refractive power, an object-side surface S5 thereof is convex, and an image-side surface S6 thereof is concave. The fourth lens E4 has positive refractive power, an object-side surface S7 thereof is concave, and an image-side surface S8 thereof is convex. The fifth lens E5 has positive refractive power, an object-side surface S9 thereof is convex, and an image-side surface S10 thereof is concave. The sixth lens E6 has negative refractive power, an object-side surface S11 thereof is convex, and an image-side surface S12 thereof is concave. The seventh lens E7 has positive refractive power, an object-side surface S13 thereof is convex, and an image-side surface S14 thereof is concave. The eighth lens E8 has negative refractive power, an object-side surface S15 thereof is concave, and an image-side surface S16 thereof is concave. The optical filter E9 has an object-side surface S17 and an image-side surface S18. Light from an object sequentially passes through the respective surfaces S1 to S18 and is finally imaged on the imaging plane S19.

In this example, a total effective focal length f of the camera lens assembly is 6.65 mm, a total length TTL of the camera lens assembly is 7.86 mm, half of a diagonal length ImgH of an effective pixel area on the imaging plane S19 of the camera lens assembly is 6.02 mm, half of a maximal field-of-view Semi-FOV of the camera lens assembly is 40.87°, and an aperture value Fno of the camera lens assembly is 1.57.

Table 5 is a table illustrating basic parameters of the camera lens assembly of example 3, wherein the units for the radius of curvature, the thickness/distance and the focal length are millimeter (mm). Table 6 shows high-order coefficients applicable to each aspheric surface in example 3, wherein the surface shape of each aspheric surface may be defined by the formula (1) given in the above example 1.

TABLE 5

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.9540 | | | | |
| S1 | Aspheric | 2.7189 | 1.1090 | 1.55 | 56.1 | 5.71 | −0.3364 |
| S2 | Aspheric | 18.1451 | 0.0757 | | | | 0.0000 |
| S3 | Aspheric | 6.5056 | 0.2200 | 1.68 | 19.2 | −11.29 | 6.4931 |
| S4 | Aspheric | 3.4719 | 0.3032 | | | | −0.2663 |
| S5 | Aspheric | 8.5466 | 0.4367 | 1.57 | 37.3 | 36.80 | 0.0000 |
| S6 | Aspheric | 14.1335 | 0.4432 | | | | 0.0000 |
| S7 | Aspheric | −42.0514 | 0.4505 | 1.64 | 23.4 | 341.25 | 0.0000 |
| S8 | Aspheric | −35.4256 | 0.4004 | | | | 0.0000 |
| S9 | Aspheric | 7.0627 | 0.2800 | 1.68 | 19.2 | 499.98 | 0.0000 |
| S10 | Aspheric | 7.0970 | 0.4158 | | | | −12.6298 |
| S11 | Aspheric | 41.4120 | 0.4002 | 1.57 | 37.3 | −59.45 | 14.3931 |
| S12 | Aspheric | 18.5937 | 0.3243 | | | | 0.0000 |
| S13 | Aspheric | 3.7857 | 0.6637 | 1.55 | 56.1 | 8.24 | −1.0000 |
| S14 | Aspheric | 22.3326 | 1.0859 | | | | 26.6775 |
| S15 | Aspheric | −5.0998 | 0.3800 | 1.54 | 55.9 | −4.92 | −1.9693 |
| S16 | Aspheric | 5.6334 | 0.1141 | | | | −0.0343 |
| S17 | Spherical | Infinite | 0.1100 | 1.52 | 64.2 | | |
| S18 | Spherical | Infinite | 0.6477 | | | | |
| S19 | Spherical | Infinite | | | | | |

TABLE 6

| Surface | | | | | |
|---|---|---|---|---|---|
| number | A4 | A6 | A8 | A10 | A12 |
| S1 | 1.7894E−03 | 8.8771E−04 | −6.0733E−04 | 2.4623E−04 | −1.7624E−05 |
| S2 | 9.8951E−03 | −1.1705E−02 | 1.0933E−02 | −7.6004E−03 | 3.8581E−03 |
| S3 | −8.9598E−03 | −8.6000E−03 | 1.0630E−02 | −6.7123E−03 | 2.6486E−03 |
| S4 | −1.2870E−02 | 1.2601E−03 | 1.1254E−03 | 5.7773E−04 | −9.7955E−04 |
| S5 | 7.8012E−06 | −4.9077E−04 | 2.2527E−03 | −2.8954E−03 | 3.3694E−03 |
| S6 | −3.4803E−03 | 6.0477E−03 | −1.1190E−02 | 1.6058E−02 | −1.4318E−02 |
| S7 | −2.4570E−02 | 1.0545E−02 | −2.2756E−02 | 2.6614E−02 | −2.1070E−02 |
| S8 | −2.4662E−02 | 1.2731E−03 | 1.1901E−03 | −4.5855E−03 | 4.2809E−03 |
| S9 | −2.1463E−02 | −6.3358E−03 | 4.5752E−03 | −1.7619E−03 | 3.7103E−04 |
| S10 | −2.0913E−03 | −1.7486E−02 | 1.1388E−02 | −4.4724E−03 | 1.0928E−03 |
| S11 | 2.1348E−02 | −2.2086E−02 | 1.0468E−02 | −3.0101E−03 | 4.3637E−04 |
| S12 | 2.3754E−03 | −2.0693E−02 | 1.2046E−02 | −3.3996E−03 | 3.0006E−04 |
| S13 | −8.8987E−04 | −1.4266E−02 | 6.8759E−03 | −3.2698E−03 | 1.4095E−03 |
| S14 | 1.9550E−02 | −1.0058E−02 | 7.1148E−04 | −1.2409E−04 | 3.0880E−04 |
| S15 | −5.3828E−02 | 2.9078E−02 | −1.5752E−02 | 5.8845E−03 | −1.3609E−03 |
| S16 | −6.0190E−02 | 2.6085E−02 | −1.0676E−02 | 3.1625E−03 | −6.3531E−04 |

| Surface | | | | |
|---|---|---|---|---|
| number | A14 | A16 | A18 | A20 |
| S1 | −2.0259E−05 | 6.8137E−06 | −7.7522E−07 | 1.4064E−08 |
| S2 | −1.4231E−03 | 3.6950E−04 | −6.3534E−05 | 6.4160E−06 |
| S3 | −6.5506E−04 | 9.7432E−05 | −8.2247E−06 | 3.4391E−07 |
| S4 | 3.7140E−04 | 1.3303E−05 | −3.2831E−05 | 4.7432E−06 |
| S5 | −2.2854E−03 | 9.2925E−04 | −2.0120E−04 | 1.7659E−05 |
| S6 | 8.6334E−03 | −3.4644E−03 | 8.9971E−04 | −1.3737E−04 |
| S7 | 1.0834E−02 | −3.4493E−03 | 6.1587E−04 | −4.7069E−05 |
| S8 | −2.1641E−03 | 6.4352E−04 | −1.0595E−04 | 7.5081E−06 |
| S9 | −6.3611E−05 | 1.6573E−05 | −3.3960E−06 | 2.6487E−07 |
| S10 | −1.5947E−04 | 1.2388E−05 | −3.6214E−07 | −3.0442E−09 |
| S11 | −5.1724E−07 | −1.0630E−05 | 1.6947E−06 | −1.1377E−07 |
| S12 | 1.1157E−04 | −4.5760E−05 | 8.1806E−06 | −8.5819E−07 |
| S13 | −4.3903E−04 | 9.2522E−05 | −1.3259E−05 | 1.3092E−06 |
| S14 | −1.4311E−04 | 3.3419E−05 | −4.8336E−06 | 4.6637E−07 |
| S15 | 2.0234E−04 | −1.9895E−05 | 1.2854E−06 | −5.0795E−08 |
| S16 | 8.7986E−05 | −8.6051E−06 | 6.0295E−07 | −3.0340E−08 |

FIG. 6A illustrates a longitudinal aberration curve of the camera lens assembly according to example 3, representing deviations of focal points converged by light of different wavelengths after passing through the lens assembly. FIG. 6B illustrates an astigmatic curve of the camera lens assembly according to example 3, representing a curvature of a tangential plane and a curvature of a sagittal plane. FIG. 6C illustrates a distortion curve of the camera lens assembly according to example 3, representing amounts of distortion corresponding to different image heights. FIG. 6D illustrates a lateral color curve of the camera lens assembly according to example 3, representing deviations of different image heights on an imaging plane after light passes through the lens assembly. It can be seen from FIG. 6A to FIG. 6D that the camera lens assembly provided in example 3 may achieve good image quality.

### Example 4

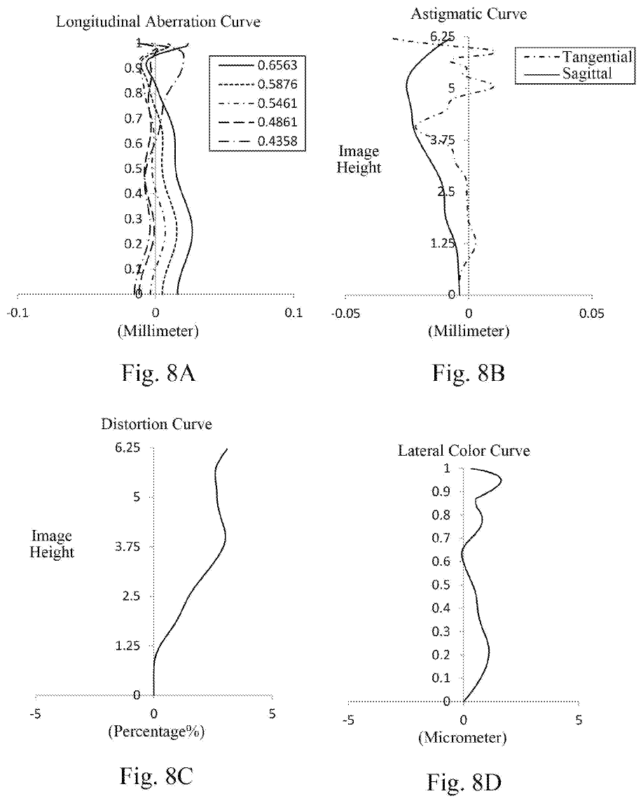

A camera lens assembly according to example 4 of the present disclosure is described below with reference to FIG. 7 to FIG. 8D. FIG. 7 shows a schematic structural view of the camera lens assembly according to example 4 of the present disclosure.

As shown in FIG. 7, the camera lens assembly includes a stop STO, a first lens E1, a second lens E2, a third lens E3, a fourth lens E4, a fifth lens E5, a sixth lens E6, a seventh lens E7, an eighth lens E8, an optical filter E9 and an imaging plane S19, which are sequentially arranged from an object side to an image side.

The first lens E1 has positive refractive power, an object-side surface S1 thereof is convex, and an image-side surface S2 thereof is concave. The second lens E2 has negative refractive power, an object-side surface S3 thereof is convex, and an image-side surface S4 thereof is concave. The third lens E3 has positive refractive power, an object-side surface S5 thereof is convex, and an image-side surface S6 thereof is concave. The fourth lens E4 has positive refractive power, an object-side surface S7 thereof is concave, and an image-side surface S8 thereof is convex. The fifth lens E5 has negative refractive power, an object-side surface S9 thereof is convex, and an image-side surface S10 thereof is concave. The sixth lens E6 has negative refractive power, an object-side surface S11 thereof is convex, and an image-side surface S12 thereof is concave. The seventh lens E7 has positive refractive power, an object-side surface S13 thereof is convex, and an image-side surface S14 thereof is concave. The eighth lens E8 has negative refractive power, an object-side surface S15 thereof is concave, and an image-side surface S16 thereof is concave. The optical filter E9 has an object-side surface S17 and an image-side surface S18. Light from an object sequentially passes through the respective surfaces S1 to S18 and is finally imaged on the imaging plane S19.

In this example, a total effective focal length f of the camera lens assembly is 6.63 mm, a total length TTL of the camera lens assembly is 7.92 mm, half of a diagonal length ImgH of an effective pixel area on the imaging plane S19 of the camera lens assembly is 6.22 mm, half of a maximal field-of-view Semi-FOV of the camera lens assembly is 41.86°, and an aperture value Fno of the camera lens assembly is 1.55.

Table 7 is a table illustrating basic parameters of the camera lens assembly of example 4, wherein the units for the radius of curvature, the thickness/distance and the focal length are millimeter (mm). Table 8 shows high-order coefficients applicable to each aspheric surface in example 4, wherein the surface shape of each aspheric surface may be defined by the formula (1) given in the above example 1.

TABLE 7

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.9531 | | | | |
| S1 | Aspheric | 2.7508 | 1.1381 | 1.55 | 56.1 | 5.76 | −0.3438 |
| S2 | Aspheric | 18.6138 | 0.0500 | | | | 0.0000 |
| S3 | Aspheric | 6.6079 | 0.2200 | 1.68 | 19.2 | −11.43 | 6.6515 |
| S4 | Aspheric | 3.5218 | 0.2674 | | | | −0.3191 |
| S5 | Aspheric | 8.1698 | 0.4428 | 1.57 | 37.3 | 41.75 | 0.0000 |
| S6 | Aspheric | 12.1817 | 0.4256 | | | | 0.0000 |
| S7 | Aspheric | −2960.4454 | 0.4763 | 1.64 | 23.4 | 52.41 | 0.0000 |
| S8 | Aspheric | −33.2605 | 0.5643 | | | | 0.0000 |
| S9 | Aspheric | 7.5460 | 0.2800 | 1.68 | 19.2 | −91.05 | 0.0000 |
| S10 | Aspheric | 6.6247 | 0.3040 | | | | −8.4958 |
| S11 | Aspheric | 85.6250 | 0.4884 | 1.57 | 37.3 | −600.00 | −31.4547 |
| S12 | Aspheric | 68.3676 | 0.2997 | | | | 0.0000 |
| S13 | Aspheric | 4.4503 | 0.6650 | 1.55 | 56.1 | 9.77 | 0.0000 |
| S14 | Aspheric | 25.3627 | 1.0900 | | | | 27.3988 |
| S15 | Aspheric | −5.3430 | 0.4705 | 1.54 | 55.9 | −4.76 | −2.6474 |
| S16 | Aspheric | 5.0669 | 0.1233 | | | | −0.1394 |
| S17 | Spherical | Infinite | 0.1100 | 1.52 | 64.2 | | |
| S18 | Spherical | Infinite | 0.5061 | | | | |
| S19 | Spherical | Infinite | | | | | |

TABLE 8

| Surface | | | | | |
|---|---|---|---|---|---|
| number | A4 | A6 | A8 | A10 | A12 |
| S1 | 1.8997E−03 | 1.9368E−04 | 5.9825E−04 | −8.9093E−04 | 6.2238E−04 |
| S2 | 9.4525E−03 | −1.2968E−02 | 1.3558E−02 | −9.9138E−03 | 4.8413E−03 |
| S3 | −1.0874E−02 | −8.3647E−03 | 1.4129E−02 | −1.2170E−02 | 6.5652E−03 |
| S4 | −1.3866E−02 | −1.7938E−03 | 1.2127E−02 | −1.5217E−02 | 1.1252E−02 |
| S5 | −1.1954E−03 | −1.6792E−03 | 6.2069E−03 | −8.2358E−03 | 6.9334E−03 |
| S6 | −3.2297E−03 | −1.2366E−03 | 9.7570E−03 | −1.7826E−02 | 2.0142E−02 |
| S7 | −1.9048E−02 | −1.3880E−03 | 1.5639E−03 | −4.8059E−03 | 5.0519E−03 |
| S8 | −1.6838E−02 | −6.8764E−03 | 1.1791E−02 | −1.4511E−02 | 1.0545E−02 |
| S9 | −1.5058E−02 | −1.4170E−02 | 1.4252E−02 | −9.0335E−03 | 3.8043E−03 |
| S10 | 2.8757E−03 | −2.2976E−02 | 1.5300E−02 | −6.0840E−03 | 1.5141E−03 |
| S11 | 3.3388E−02 | −3.1356E−02 | 1.3988E−02 | −3.5320E−03 | 3.9374E−04 |
| S12 | 2.2307E−02 | −3.2545E−02 | 1.6327E−02 | −4.6392E−03 | 7.2792E−04 |
| S13 | 7.9750E−03 | −1.6722E−02 | 7.0334E−03 | −3.7202E−03 | 1.7931E−03 |
| S14 | 1.5583E−02 | −1.1443E−03 | −5.1483E−03 | 2.0826E−03 | −3.0409E−04 |
| S15 | −4.4682E−02 | 2.7503E−02 | −1.2753E−02 | 3.2353E−03 | −3.4714E−04 |
| S16 | −6.0492E−02 | 2.9698E−02 | −1.1390E−02 | 2.8670E−03 | −4.7760E−04 |

| Surface | | | | |
|---|---|---|---|---|
| number | A14 | A16 | A18 | A20 |
| S1 | −2.4405E−04 | 5.4512E−05 | −6.4605E−06 | 3.0599E−07 |
| S2 | −1.5604E−03 | 3.2733E−04 | −4.3323E−05 | 3.3144E−06 |
| S3 | −2.2077E−03 | 4.4789E−04 | −5.0425E−05 | 2.4459E−06 |
| S4 | −5.1684E−03 | 1.4788E−03 | −2.4084E−04 | 1.6894E−05 |
| S5 | −3.5487E−03 | 1.1348E−03 | −2.0409E−04 | 1.5549E−05 |
| S6 | −1.4205E−02 | 6.3549E−03 | −1.7366E−03 | 2.6313E−04 |
| S7 | −2.9575E−03 | 1.0138E−03 | −1.9134E−04 | 1.5472E−05 |
| S8 | −4.7312E−03 | 1.2940E−03 | −1.9820E−04 | 1.3097E−05 |
| S9 | −1.0908E−03 | 2.0326E−04 | −2.1913E−05 | 1.0231E−06 |
| S10 | −2.3687E−04 | 2.2712E−05 | −1.2371E−06 | 3.0042E−08 |
| S11 | 2.4729E−05 | −1.3671E−05 | 1.7704E−06 | −1.0407E−07 |
| S12 | −3.3811E−05 | −1.0831E−05 | 2.7462E−06 | −3.1980E−07 |
| S13 | −5.8355E−04 | 1.2467E−04 | −1.7944E−05 | 1.7761E−06 |
| S14 | −6.7755E−06 | 9.5609E−06 | −1.6838E−06 | 1.6268E−07 |
| S15 | −2.1350E−05 | 1.2118E−05 | −1.8507E−06 | 1.6429E−07 |
| S16 | 5.3930E−05 | −4.1547E−06 | 2.1288E−07 | −6.5654E−09 |

FIG. 8A illustrates a longitudinal aberration curve of the camera lens assembly according to example 4, representing deviations of focal points converged by light of different wavelengths after passing through the lens assembly. FIG. 8B illustrates an astigmatic curve of the camera lens assembly according to example 4, representing a curvature of a tangential plane and a curvature of a sagittal plane. FIG. 8C illustrates a distortion curve of the camera lens assembly according to example 4, representing amounts of distortion corresponding to different image heights. FIG. 8D illustrates a lateral color curve of the camera lens assembly according to example 4, representing deviations of different image heights on an imaging plane after light passes through the lens assembly. It can be seen from FIG. 8A to FIG. 8D that the camera lens assembly provided in example 4 may achieve good image quality.

### Example 5

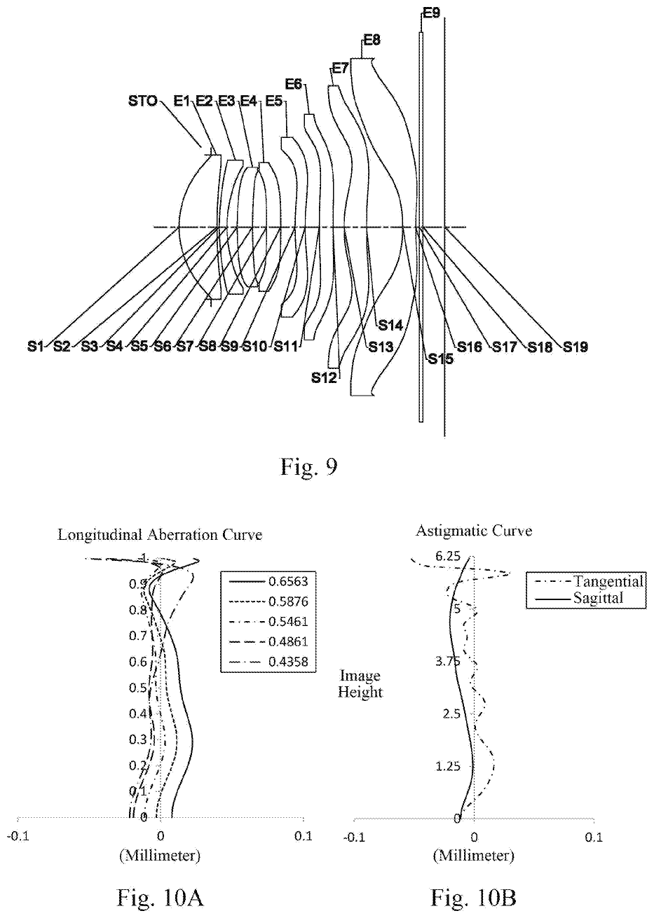

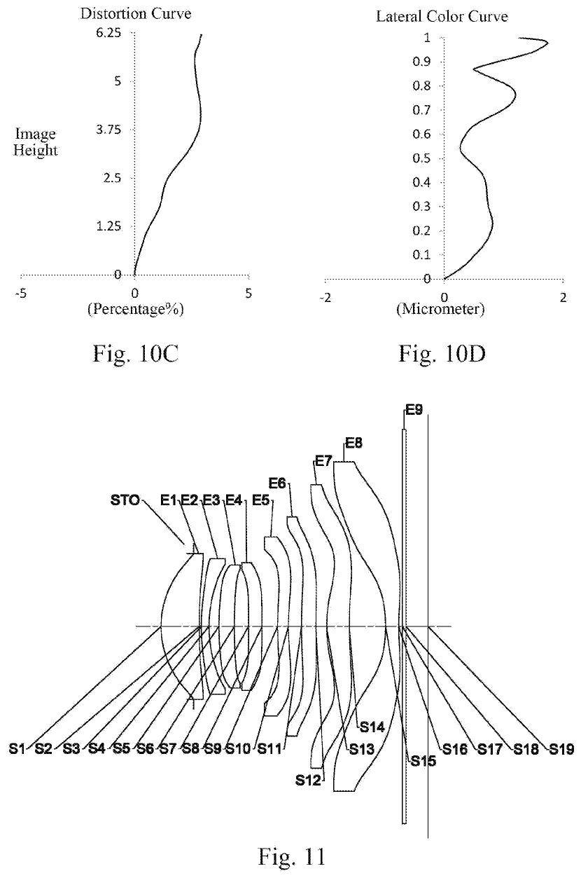

A camera lens assembly according to example 5 of the present disclosure is described below with reference to FIG. 9 to FIG. 10D. FIG. 9 shows a schematic structural view of the camera lens assembly according to example 5 of the present disclosure.

As shown in FIG. 9, the camera lens assembly includes a stop STO, a first lens E1, a second lens E2, a third lens E3, a fourth lens E4, a fifth lens E5, a sixth lens E6, a seventh lens E7, an eighth lens E8, an optical filter E9 and an imaging plane S19, which are sequentially arranged from an object side to an image side.

The first lens E1 has positive refractive power, an object-side surface S1 thereof is convex, and an image-side surface S2 thereof is concave. The second lens E2 has negative refractive power, an object-side surface S3 thereof is convex, and an image-side surface S4 thereof is concave. The third lens E3 has positive refractive power, an object-side surface S5 thereof is convex, and an image-side surface S6 thereof is concave. The fourth lens E4 has positive refractive power, an object-side surface S7 thereof is concave, and an image-side surface S8 thereof is convex. The fifth lens E5 has positive refractive power, an object-side surface S9 thereof is convex, and an image-side surface S10 thereof is concave. The sixth lens E6 has negative refractive power, an object-side surface S11 thereof is convex, and an image-side surface S12 thereof is concave. The seventh lens E7 has positive refractive power, an object-side surface S13 thereof is convex, and an image-side surface S14 thereof is concave. The eighth lens E8 has negative refractive power, an object-side surface S15 thereof is concave, and an image-side surface S16 thereof is concave. The optical filter E9 has an object-side surface S17 and an image-side surface S18. Light from an object sequentially passes through the respective surfaces S1 to S18 and is finally imaged on the imaging plane S19.

In this example, a total effective focal length f of the camera lens assembly is 6.66 mm, a total length TTL of the camera lens assembly is 7.85 mm, half of a diagonal length ImgH of an effective pixel area on the imaging plane S19 of the camera lens assembly is 6.22 mm, half of a maximal field-of-view Semi-FOV of the camera lens assembly is 41.70°, and an aperture value Fno of the camera lens assembly is 1.56.

Table 9 is a table illustrating basic parameters of the camera lens assembly of example 5, wherein the units for the radius of curvature, the thickness/distance and the focal length are millimeter (mm). Table 10 shows high-order coefficients applicable to each aspheric surface in example 5, wherein the surface shape of each aspheric surface may be defined by the formula (1) given in the above example 1.

TABLE 9

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.9463 | | | | |
| S1 | Aspheric | 2.7126 | 1.1230 | 1.55 | 56.1 | 5.71 | −0.3578 |
| S2 | Aspheric | 17.6297 | 0.0620 | | | | 0.0000 |
| S3 | Aspheric | 6.5042 | 0.2294 | 1.68 | 19.2 | −11.10 | 6.4961 |
| S4 | Aspheric | 3.4427 | 0.2988 | | | | −0.2978 |
| S5 | Aspheric | 9.0518 | 0.4572 | 1.57 | 37.3 | 34.47 | 0.0000 |
| S6 | Aspheric | 16.4445 | 0.4157 | | | | 0.0000 |
| S7 | Aspheric | −124.7358 | 0.4168 | 1.64 | 23.4 | 293.85 | 0.0000 |
| S8 | Aspheric | −75.1761 | 0.4241 | | | | 0.0000 |
| S9 | Aspheric | 6.7915 | 0.2970 | 1.68 | 19.2 | 1443.18 | 0.0000 |
| S10 | Aspheric | 6.7178 | 0.4191 | | | | −14.0903 |
| S11 | Aspheric | 39.5196 | 0.4065 | 1.57 | 37.3 | −200.31 | −15.3613 |
| S12 | Aspheric | 29.2645 | 0.3251 | | | | 0.0000 |
| S13 | Aspheric | 4.1649 | 0.6650 | 1.55 | 56.1 | 9.25 | 0.0000 |
| S14 | Aspheric | 22.3384 | 1.0674 | | | | 26.6607 |
| S15 | Aspheric | −5.0990 | 0.3800 | 1.54 | 55.9 | −4.92 | −2.0141 |
| S16 | Aspheric | 5.6283 | 0.1093 | | | | −0.0186 |
| S17 | Spherical | Infinite | 0.1100 | 1.52 | 64.2 | | |
| S18 | Spherical | Infinite | 0.6443 | | | | |
| S19 | Spherical | Infinite | | | | | |

TABLE 10

| Surface | | | | | |
|---|---|---|---|---|---|
| number | A4 | A6 | A8 | A10 | A12 |
| S1 | 2.0432E−03 | 4.1739E−04 | 3.3014E−05 | −2.9983E−04 | 2.7570E−04 |
| S2 | 1.1051E−02 | −1.3682E−02 | 1.2995E−02 | −8.9147E−03 | 4.3496E−03 |
| S3 | −8.4390E−03 | −9.9908E−03 | 1.2717E−02 | −8.6285E−03 | 3.7678E−03 |
| S4 | −1.3427E−02 | 2.4936E−03 | −6.2311E−04 | 2.3356E−03 | −2.2706E−03 |
| S5 | −3.2637E−05 | 1.7575E−03 | −3.0974E−03 | 4.6158E−03 | −3.1129E−03 |
| S6 | −3.2426E−03 | 3.8919E−03 | −5.2903E−03 | 7.2363E−03 | −5.8716E−03 |
| S7 | −2.5949E−02 | 1.1486E−02 | −2.1147E−02 | 2.0794E−02 | −1.3627E−02 |
| S8 | −2.5480E−02 | 2.4410E−03 | 4.0219E−04 | −4.7401E−03 | 4.8978E−03 |
| S9 | −2.4756E−02 | −1.9840E−03 | 1.4888E−03 | −3.5726E−04 | −2.6096E−05 |
| S10 | −4.7701E−03 | −1.4873E−02 | 1.0191E−02 | −4.1541E−03 | 1.0403E−03 |
| S11 | 2.9480E−02 | −3.2935E−02 | 1.7768E−02 | −5.9909E−03 | 1.2188E−03 |
| S12 | 2.3341E−02 | −4.0236E−02 | 2.3492E−02 | −7.9882E−03 | 1.6358E−03 |
| S13 | 9.3133E−03 | −2.1495E−02 | 1.0074E−02 | −4.7622E−03 | 2.0464E−03 |
| S14 | 1.9410E−02 | −6.8575E−03 | −1.9480E−03 | 7.5134E−04 | 1.9820E−04 |
| S15 | −7.2719E−02 | 5.6534E−02 | −3.4693E−02 | 1.3502E−02 | −3.3213E−03 |
| S16 | −7.9563E−02 | 4.6596E−02 | −2.1844E−02 | 6.8603E−03 | −1.4443E−03 |

| Surface | | | | |
|---|---|---|---|---|
| number | A14 | A16 | A18 | A20 |
| S1 | −1.2269E−04 | 2.9374E−05 | −3.6350E−06 | 1.7203E−07 |
| S2 | −1.5118E−03 | 3.6697E−04 | −5.9347E−05 | 5.7231E−06 |
| S3 | −1.0604E−03 | 1.8398E−04 | −1.8039E−05 | 7.8931E−07 |
| S4 | 1.0307E−03 | −2.0212E−04 | 7.1190E−06 | 1.5593E−06 |
| S5 | 1.1682E−03 | −1.7363E−04 | −7.6689E−06 | 3.2978E−06 |
| S6 | 3.2784E−03 | −1.2235E−03 | 3.0727E−04 | −4.8366E−05 |
| S7 | 5.7934E−03 | −1.5230E−03 | 2.2293E−04 | −1.3749E−05 |
| S8 | −2.5837E−03 | 7.8222E−04 | −1.2934E−04 | 9.1261E−06 |
| S9 | −1.4621E−06 | 1.3357E−05 | −3.7862E−06 | 3.1048E−07 |
| S10 | −1.5384E−04 | 1.2014E−05 | −3.5086E−07 | −3.0198E−09 |
| S11 | −1.3662E−04 | 5.0547E−06 | 5.4248E−07 | −6.5003E−08 |
| S12 | −1.7874E−04 | 1.1380E−06 | 2.6949E−06 | −4.1214E−07 |
| S13 | −6.3887E−04 | 1.3585E−04 | −1.9757E−05 | 1.9884E−06 |
| S14 | −1.5342E−04 | 3.9458E−05 | −5.8839E−06 | 5.7194E−07 |
| S15 | 5.4415E−04 | −6.1698E−05 | 4.9384E−06 | −2.8007E−07 |
| S16 | 2.1096E−04 | −2.1985E−05 | 1.6603E−06 | −9.1174E−08 |

FIG. 10A illustrates a longitudinal aberration curve of the camera lens assembly according to example 5, representing deviations of focal points converged by light of different wavelengths after passing through the lens assembly. FIG. 10B illustrates an astigmatic curve of the camera lens assembly according to example 5, representing a curvature of a tangential plane and a curvature of a sagittal plane. FIG. 10C illustrates a distortion curve of the camera lens assembly according to example 5, representing amounts of distortion corresponding to different image heights. FIG. 10D illustrates a lateral color curve of the camera lens assembly according to example 5, representing deviations of different image heights on an imaging plane after light passes through the lens assembly. It can be seen from FIG. 10A to FIG. 10D that the camera lens assembly provided in example 5 may achieve good image quality.

### Example 6

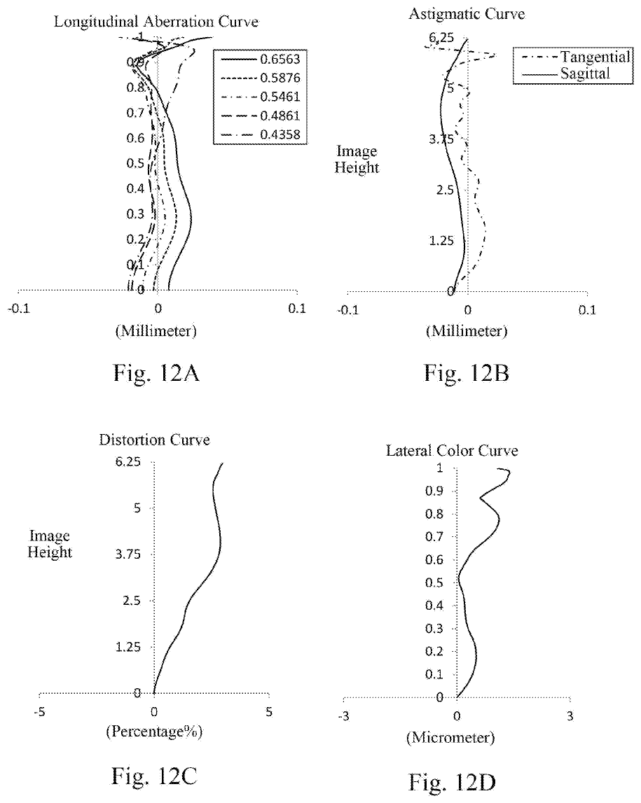

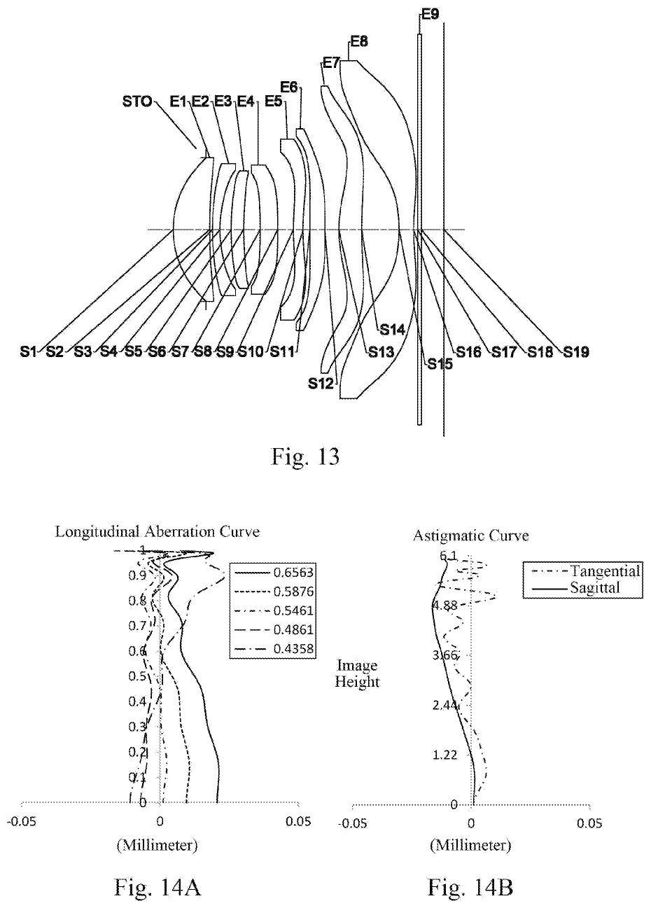

A camera lens assembly according to example 6 of the present disclosure is described below with reference to FIG. 11 to FIG. 12D. FIG. 11 shows a schematic structural view of the camera lens assembly according to example 6 of the present disclosure.

As shown in FIG. 11, the camera lens assembly includes a stop STO, a first lens E1, a second lens E2, a third lens E3, a fourth lens E4, a fifth lens E5, a sixth lens E6, a seventh lens E7, an eighth lens E8, an optical filter E9 and an imaging plane S19, which are sequentially arranged from an object side to an image side.

The first lens E1 has positive refractive power, an object-side surface S1 thereof is convex, and an image-side surface S2 thereof is concave. The second lens E2 has negative refractive power, an object-side surface S3 thereof is convex, and an image-side surface S4 thereof is concave. The third lens E3 has positive refractive power, an object-side surface S5 thereof is convex, and an image-side surface S6 thereof is concave. The fourth lens E4 has positive refractive power, an object-side surface S7 thereof is convex, and an image-side surface S8 thereof is concave. The fifth lens E5 has negative refractive power, an object-side surface S9 thereof is convex, and an image-side surface S10 thereof is concave. The sixth lens E6 has positive refractive power, an object-side surface S11 thereof is convex, and an image-side surface S12 thereof is concave. The seventh lens E7 has positive refractive power, an object-side surface S13 thereof is convex, and an image-side surface S14 thereof is concave. The eighth lens E8 has negative refractive power, an object-side surface S15 thereof is concave, and an image-side surface S16 thereof is concave. The optical filter E9 has an object-side surface S17 and an image-side surface S18. Light from an object sequentially passes through the respective surfaces S1 to S18 and is finally imaged on the imaging plane S19.

In this example, a total effective focal length f of the camera lens assembly is 6.60 mm, a total length TTL of the camera lens assembly is 7.82 mm, half of a diagonal length ImgH of an effective pixel area on the imaging plane S19 of the camera lens assembly is 6.22 mm, half of a maximal field-of-view Semi-FOV of the camera lens assembly is 41.96°, and an aperture value Fno of the camera lens assembly is 1.54.

Table 11 is a table illustrating basic parameters of the camera lens assembly of example 6, wherein the units for the radius of curvature, the thickness/distance and the focal length are millimeter (mm). Table 12 shows high-order coefficients applicable to each aspheric surface in example 6, wherein the surface shape of each aspheric surface may be defined by the formula (1) given in the above example 1.

TABLE 11

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.9470 | | | | |
| S1 | Aspheric | 2.7127 | 1.1147 | 1.55 | 56.1 | 5.75 | −0.3648 |
| S2 | Aspheric | 16.9253 | 0.0639 | | | | 0.0000 |
| S3 | Aspheric | 6.5212 | 0.2200 | 1.68 | 19.2 | −11.32 | 6.4682 |
| S4 | Aspheric | 3.4814 | 0.2935 | | | | −0.2835 |
| S5 | Aspheric | 9.0290 | 0.4539 | 1.57 | 37.3 | 37.51 | 0.0000 |
| S6 | Aspheric | 15.3179 | 0.4123 | | | | 0.0000 |
| S7 | Aspheric | 63.1234 | 0.3987 | 1.64 | 23.4 | 112.53 | 0.0000 |
| S8 | Aspheric | 500.0000 | 0.4530 | | | | 0.0000 |
| S9 | Aspheric | 7.2636 | 0.3169 | 1.68 | 19.2 | −111.54 | 0.0000 |
| S10 | Aspheric | 6.5113 | 0.3861 | | | | −15.2212 |
| S11 | Aspheric | 31.9756 | 0.4194 | 1.57 | 37.3 | 326.19 | −20.9757 |
| S12 | Aspheric | 38.4154 | 0.3140 | | | | 0.0000 |
| S13 | Aspheric | 4.1319 | 0.6650 | 1.55 | 56.1 | 9.16 | 0.0000 |
| S14 | Aspheric | 22.3197 | 1.0611 | | | | 26.6800 |
| S15 | Aspheric | −5.0982 | 0.3800 | 1.54 | 55.9 | −4.91 | −2.0191 |
| S16 | Aspheric | 5.6104 | 0.1092 | | | | −0.0194 |
| S17 | Spherical | Infinite | 0.1100 | 1.52 | 64.2 | | |
| S18 | Spherical | Infinite | 0.6437 | | | | |
| S19 | Spherical | Infinite | | | | | |

TABLE 12

| Surface | | | | | |
|---|---|---|---|---|---|
| number | A4 | A6 | A8 | A10 | A12 |
| S1 | 2.0737E−03 | 2.1610E−04 | 3.9194E−04 | −6.4578E−04 | 4.7121E−04 |
| S2 | 1.0339E−02 | −1.2987E−02 | 1.1474E−02 | −7.0594E−03 | 2.9619E−03 |
| S3 | −8.1714E−03 | −1.0908E−02 | 1.3315E−02 | −8.9596E−03 | 4.0202E−03 |
| S4 | −1.2061E−02 | −8.6579E−04 | 4.9351E−03 | −3.9923E−03 | 2.4071E−03 |
| S5 | −4.0276E−04 | 1.9498E−03 | −2.5631E−03 | 3.0589E−03 | −1.4084E−03 |
| S6 | −3.5714E−03 | 2.8157E−03 | −3.5144E−03 | 6.6627E−03 | −7.2060E−03 |
| S7 | −2.5728E−02 | 1.1699E−02 | −2.0679E−02 | 1.8763E−02 | −1.1118E−02 |
| S8 | −2.4732E−02 | 4.8191E−03 | −4.9670E−03 | 1.2323E−03 | 7.6333E−04 |
| S9 | −2.7023E−02 | −8.5694E−04 | 2.4714E−03 | −1.5122E−03 | 5.4096E−04 |
| S10 | −7.6677E−03 | −1.3470E−02 | 1.0241E−02 | −4.3398E−03 | 1.0984E−03 |
| S11 | 2.9562E−02 | −3.2065E−02 | 1.6474E−02 | −5.1717E−03 | 9.3589E−04 |
| S12 | 2.2511E−02 | −3.8002E−02 | 2.1541E−02 | −7.1291E−03 | 1.4454E−03 |
| S13 | 7.2208E−03 | −1.8285E−02 | 7.0396E−03 | −3.0673E−03 | 1.4203E−03 |
| S14 | 1.8084E−02 | −3.9023E−03 | −4.3702E−03 | 1.8738E−03 | −1.4377E−04 |
| S15 | −7.7943E−02 | 6.5004E−02 | −4.0761E−02 | 1.5997E−02 | −3.9808E−03 |
| S16 | −8.2731E−02 | 5.0947E−02 | −2.4318E−02 | 7.6733E−03 | −1.6202E−03 |

| Surface | | | | |
|---|---|---|---|---|
| number | A14 | A16 | A18 | A20 |
| S1 | −1.9078E−04 | 4.3697E−05 | −5.3003E−06 | 2.5421E−07 |
| S2 | −8.3046E−04 | 1.4844E−04 | −1.5611E−05 | 7.9316E−07 |
| S3 | −1.1996E−03 | 2.2656E−04 | −2.4683E−05 | 1.2052E−06 |
| S4 | −1.1419E−03 | 4.0532E−04 | −8.5888E−05 | 7.5438E−06 |
| S5 | 1.8110E−04 | 1.4362E−04 | −6.0804E−05 | 6.9033E−06 |
| S6 | 5.1278E−03 | −2.3235E−03 | 6.6382E−04 | −1.1018E−04 |
| S7 | 4.1835E−03 | −9.3932E−04 | 1.0929E−04 | −4.4089E−06 |
| S8 | −7.9862E−04 | 3.1566E−04 | −6.1788E−05 | 4.9746E−06 |
| S9 | −1.7153E−04 | 4.5110E−05 | −7.1245E−06 | 4.5973E−07 |
| S10 | −1.6389E−04 | 1.3321E−05 | −4.7067E−07 | 1.9916E−09 |
| S11 | −7.8922E−05 | −2.0365E−06 | 1.0550E−06 | −8.4881E−08 |
| S12 | −1.6689E−04 | 5.4962E−06 | 1.4091E−06 | −2.4565E−07 |
| S13 | −4.7792E−04 | 1.0637E−04 | −1.5864E−05 | 1.6171E−06 |
| S14 | −8.0123E−05 | 2.8056E−05 | −4.5820E−06 | 4.6298E−07 |
| S15 | 6.6331E−04 | −7.6951E−05 | 6.3478E−06 | −3.7460E−07 |
| S16 | 2.3758E−04 | −2.4894E−05 | 1.8930E−06 | −1.0481E−07 |

FIG. 12A illustrates a longitudinal aberration curve of the camera lens assembly according to example 6, representing deviations of focal points converged by light of different wavelengths after passing through the lens assembly. FIG. 12B illustrates an astigmatic curve of the camera lens assembly according to example 6, representing a curvature of a tangential plane and a curvature of a sagittal plane. FIG. 12C illustrates a distortion curve of the camera lens assembly according to example 6, representing amounts of distortion corresponding to different image heights. FIG. 12D illustrates a lateral color curve of the camera lens assembly according to example 6, representing deviations of different image heights on an imaging plane after light passes through the lens assembly. It can be seen from FIG. 12A to FIG. 12D that the camera lens assembly provided in example 6 may achieve good image quality.

### Example 7

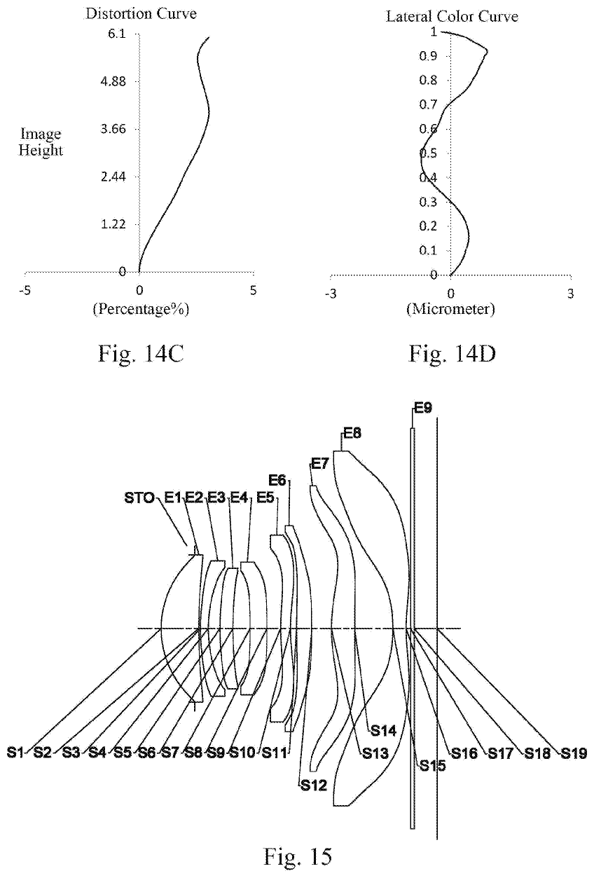

A camera lens assembly according to example 7 of the present disclosure is described below with reference to FIG. 13 to FIG. 14D. FIG. 13 shows a schematic structural view of the camera lens assembly according to example 7 of the present disclosure.

As shown in FIG. 13, the camera lens assembly includes a stop STO, a first lens E1, a second lens E2, a third lens E3, a fourth lens E4, a fifth lens E5, a sixth lens E6, a seventh lens E7, an eighth lens E8, an optical filter E9 and an imaging plane S19, which are sequentially arranged from an object side to an image side.

The first lens E1 has positive refractive power, an object-side surface S1 thereof is convex, and an image-side surface S2 thereof is concave. The second lens E2 has negative refractive power, an object-side surface S3 thereof is convex, and an image-side surface S4 thereof is concave. The third lens E3 has positive refractive power, an object-side surface S5 thereof is convex, and an image-side surface S6 thereof is concave. The fourth lens E4 has positive refractive power, an object-side surface S7 thereof is concave, and an image-side surface S8 thereof is convex. The fifth lens E5 has negative refractive power, an object-side surface S9 thereof is convex, and an image-side surface S10 thereof is concave. The sixth lens E6 has negative refractive power, an object-side surface S11 thereof is concave, and an image-side surface S12 thereof is concave. The seventh lens E7 has positive refractive power, an object-side surface S13 thereof is convex, and an image-side surface S14 thereof is concave. The eighth lens E8 has negative refractive power, an object-side surface S15 thereof is concave, and an image-side surface S16 thereof is concave. The optical filter E9 has an object-side surface S17 and an image-side surface S18. Light from an object sequentially passes through the respective surfaces S1 to S18 and is finally imaged on the imaging plane S19.

In this example, a total effective focal length f of the camera lens assembly is 6.60 mm, a total length TTL of the camera lens assembly is 7.88 mm, half of a diagonal length ImgH of an effective pixel area on the imaging plane S19 of the camera lens assembly is 6.02 mm, half of a maximal field-of-view Semi-FOV of the camera lens assembly is 41.14°, and an aperture value Fno of the camera lens assembly is 1.58.

Table 13 is a table illustrating basic parameters of the camera lens assembly of example 7, wherein the units for the radius of curvature, the thickness/distance and the focal length are millimeter (mm). Table 14 shows high-order coefficients applicable to each aspheric surface in example 7, wherein the surface shape of each aspheric surface may be defined by the formula (1) given in the above example 1.

TABLE 13

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.9525 | | | | |
| S1 | Aspheric | 2.7147 | 1.0623 | 1.55 | 56.1 | 5.79 | −0.2930 |
| S2 | Aspheric | 16.4104 | 0.0772 | | | | 0.0000 |
| S3 | Aspheric | 6.2147 | 0.2212 | 1.68 | 19.2 | −12.66 | 6.6699 |
| S4 | Aspheric | 3.5560 | 0.3274 | | | | 0.1561 |
| S5 | Aspheric | 7.7177 | 0.3659 | 1.57 | 37.3 | 47.88 | 0.0000 |
| S6 | Aspheric | 10.5663 | 0.4794 | | | | 0.0000 |
| S7 | Aspheric | −33.4267 | 0.5113 | 1.64 | 23.4 | 501.73 | 0.0000 |
| S8 | Aspheric | −30.4642 | 0.4561 | | | | 0.0000 |
| S9 | Aspheric | 8.4690 | 0.2800 | 1.68 | 19.2 | −106.08 | 0.0000 |
| S10 | Aspheric | 7.4772 | 0.1995 | | | | −10.4609 |
| S11 | Aspheric | −1202.3385 | 0.4382 | 1.57 | 37.3 | −109.38 | −99.0000 |
| S12 | Aspheric | 65.9135 | 0.4041 | | | | 0.0000 |
| S13 | Aspheric | 3.4588 | 0.6650 | 1.55 | 56.1 | 7.38 | −1.0000 |
| S14 | Aspheric | 22.5739 | 1.0900 | | | | 26.5644 |
| S15 | Aspheric | −4.8740 | 0.4231 | 1.54 | 55.9 | −4.75 | −1.8118 |
| S16 | Aspheric | 5.5315 | 0.1162 | | | | −0.2119 |
| S17 | Spherical | Infinite | 0.1100 | 1.52 | 64.2 | | |
| S18 | Spherical | Infinite | 0.6543 | | | | |
| S19 | Spherical | Infinite | | | | | |

TABLE 14

| Surface | | | | | |
|---|---|---|---|---|---|
| number | A4 | A6 | A8 | A10 | A12 |
| S1 | 1.9357E−03 | 1.5356E−03 | −2.4657E−03 | 2.6308E−03 | −1.6423E−03 |
| S2 | −3.0569E−03 | 4.0857E−03 | −2.2414E−04 | −3.6895E−03 | 4.1920E−03 |
| S3 | −2.5199E−02 | 1.4486E−02 | −8.5148E−03 | 3.8976E−03 | −1.1431E−03 |
| S4 | −1.9478E−02 | 9.5734E−03 | −7.7822E−04 | −5.1950E−03 | 6.9575E−03 |
| S5 | −1.8008E−03 | −5.1969E−03 | 1.0479E−02 | −1.3796E−02 | 1.2119E−02 |
| S6 | −3.2071E−03 | 2.3094E−03 | −7.3952E−03 | 1.0095E−02 | −7.4380E−03 |
| S7 | −1.7700E−02 | −3.0988E−05 | −7.8003E−03 | 1.1764E−02 | −1.1586E−02 |
| S8 | −1.6122E−02 | −7.5393E−03 | 1.0754E−02 | −1.2040E−02 | 8.1128E−03 |
| S9 | −9.3364E−03 | −2.7281E−02 | 2.2923E−02 | −1.0930E−02 | 3.2671E−03 |
| S10 | 1.4933E−02 | −3.7500E−02 | 2.2095E−02 | −7.3966E−03 | 1.4432E−03 |
| S11 | 1.1618E−02 | −3.8991E−03 | −7.0274E−03 | 6.0251E−03 | −2.3557E−03 |
| S12 | −4.3605E−02 | 2.3927E−02 | −1.4685E−02 | 7.1426E−03 | −2.5081E−03 |
| S13 | −2.8095E−02 | 5.1318E−03 | −1.4868E−03 | −5.4673E−04 | 6.4803E−04 |
| S14 | 1.5291E−02 | −1.2134E−02 | 5.9116E−03 | −3.4284E−03 | 1.4774E−03 |
| S15 | −3.4749E−02 | 8.2014E−03 | −6.6151E−05 | −1.3285E−03 | 6.8221E−04 |
| S16 | −4.2463E−02 | 1.1403E−02 | −2.3842E−03 | 1.7079E−04 | 6.7189E−05 |

| Surface | | | | |
|---|---|---|---|---|
| number | A14 | A16 | A18 | A20 |
| S1 | 6.2292E−04 | −1.4163E−04 | 1.7778E−05 | −9.5764E−07 |
| S2 | −2.4024E−03 | 8.1399E−04 | −1.6455E−04 | 1.8362E−05 |
| S3 | 1.6198E−04 | 8.6866E−06 | −6.5233E−06 | 6.6555E−07 |
| S4 | −4.4906E−03 | 1.6312E−03 | −3.1383E−04 | 2.4672E−05 |
| S5 | −6.6309E−03 | 2.2332E−03 | −4.1721E−04 | 3.2934E−05 |
| S6 | 3.2487E−03 | −7.6867E−04 | 7.8548E−05 | 5.4808E−07 |
| S7 | 6.9438E−03 | −2.4777E−03 | 4.8529E−04 | −4.0312E−05 |
| S8 | −3.4732E−03 | 9.2752E−04 | −1.4040E−04 | 9.2033E−06 |
| S9 | −6.7323E−04 | 1.0089E−04 | −1.0059E−05 | 4.7201E−07 |
| S10 | −1.4849E−04 | 4.5669E−06 | 4.3121E−07 | −3.0046E−08 |
| S11 | 5.4804E−04 | −7.9555E−05 | 6.9935E−06 | −3.3586E−07 |
| S12 | 6.1485E−04 | −1.0143E−04 | 1.0698E−05 | −6.5253E−07 |
| S13 | −2.4844E−04 | 5.3611E−05 | −7.3829E−06 | 6.8217E−07 |
| S14 | −4.1266E−04 | 7.6663E−05 | −9.7960E−06 | 8.7666E−07 |
| S15 | −1.7630E−04 | 2.8225E−05 | −3.0249E−06 | 2.2425E−07 |
| S16 | −2.4641E−05 | 4.1664E−06 | −4.4099E−07 | 3.1449E−08 |

FIG. 14A illustrates a longitudinal aberration curve of the camera lens assembly according to example 7, representing deviations of focal points converged by light of different wavelengths after passing through the lens assembly. FIG. 14B illustrates an astigmatic curve of the camera lens assembly according to example 7, representing a curvature of a tangential plane and a curvature of a sagittal plane. FIG. 14C illustrates a distortion curve of the camera lens assembly according to example 7, representing amounts of distortion corresponding to different image heights. FIG. 14D illustrates a lateral color curve of the camera lens assembly according to example 7, representing deviations of different image heights on an imaging plane after light passes through the lens assembly. It can be seen from FIG. 14A to FIG. 14D that the camera lens assembly provided in example 7 may achieve good image quality.

### Example 8

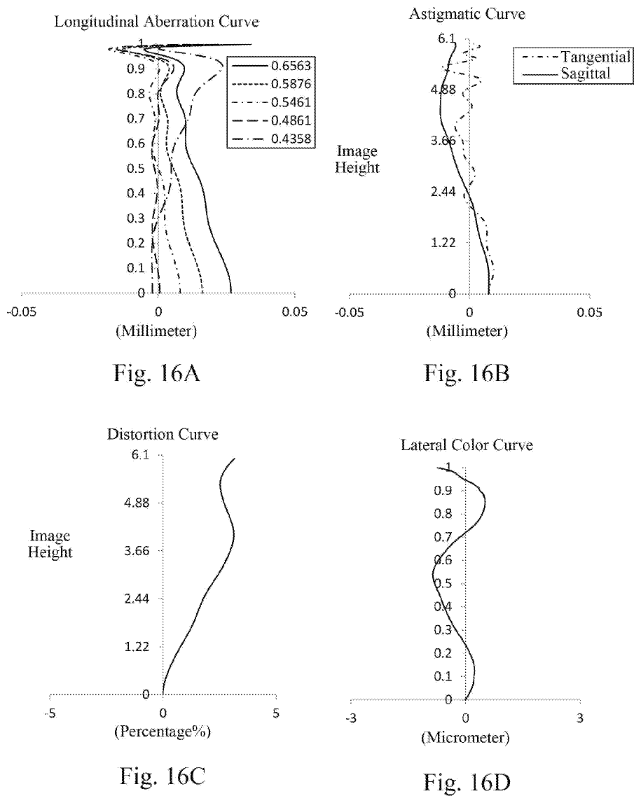

A camera lens assembly according to example 8 of the present disclosure is described below with reference to FIG. 15 to FIG. 16D. FIG. 15 shows a schematic structural view of the camera lens assembly according to example 8 of the present disclosure.

As shown in FIG. 15, the camera lens assembly includes a stop STO, a first lens E1, a second lens E2, a third lens E3, a fourth lens E4, a fifth lens E5, a sixth lens E6, a seventh lens E7, an eighth lens E8, an optical filter E9 and an imaging plane S19, which are sequentially arranged from an object side to an image side.

The first lens E1 has positive refractive power, an object-side surface S1 thereof is convex, and an image-side surface S2 thereof is concave. The second lens E2 has negative refractive power, an object-side surface S3 thereof is convex, and an image-side surface S4 thereof is concave. The third lens E3 has positive refractive power, an object-side surface S5 thereof is convex, and an image-side surface S6 thereof is concave. The fourth lens E4 has negative refractive power, an object-side surface S7 thereof is concave, and an image-side surface S8 thereof is convex. The fifth lens E5 has negative refractive power, an object-side surface S9 thereof is convex, and an image-side surface S10 thereof is concave. The sixth lens E6 has positive refractive power, an object-side surface S11 thereof is convex, and an image-side surface S12 thereof is convex. The seventh lens E7 has positive refractive power, an object-side surface S13 thereof is convex, and an image-side surface S14 thereof is convex. The eighth lens E8 has negative refractive power, an object-side surface S15 thereof is concave, and an image-side surface S16 thereof is concave. The optical filter E9 has an object-side surface S17 and an image-side surface S18. Light from an object sequentially passes through the respective surfaces S1 to S18 and is finally imaged on the imaging plane S19.

In this example, a total effective focal length f of the camera lens assembly is 6.60 mm, a total length TTL of the camera lens assembly is 7.88 mm, half of a diagonal length ImgH of an effective pixel area on the imaging plane S19 of the camera lens assembly is 6.02 mm, half of a maximal field-of-view Semi-FOV of the camera lens assembly is 41.16°, and an aperture value Fno of the camera lens assembly is 1.57.

Table 15 is a table illustrating basic parameters of the camera lens assembly of example 8, wherein the units for the radius of curvature, the thickness/distance and the focal length are millimeter (mm). Table 16 shows high-order coefficients applicable to each aspheric surface in example 8, wherein the surface shape of each aspheric surface may be defined by the formula (1) given in the above example 1.

TABLE 15

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.9622 | | | | |
| S1 | Aspheric | 2.7157 | 1.0720 | 1.55 | 56.1 | 5.82 | −0.2890 |
| S2 | Aspheric | 16.0068 | 0.0510 | | | | 0.0000 |
| S3 | Aspheric | 6.1527 | 0.2200 | 1.68 | 19.2 | −13.31 | 6.8481 |
| S4 | Aspheric | 3.6090 | 0.3326 | | | | 0.4099 |
| S5 | Aspheric | 7.9259 | 0.3722 | 1.57 | 37.3 | 69.42 | 0.0000 |
| S6 | Aspheric | 9.7364 | 0.4900 | | | | 0.0000 |
| S7 | Aspheric | −34.4391 | 0.4801 | 1.64 | 23.4 | −190.43 | 0.0000 |
| S8 | Aspheric | −48.2128 | 0.3935 | | | | 0.0000 |
| S9 | Aspheric | 6.9923 | 0.2800 | 1.68 | 19.2 | −44.53 | 0.0000 |
| S10 | Aspheric | 5.5877 | 0.1732 | | | | −16.7413 |
| S11 | Aspheric | 22.8169 | 0.4333 | 1.57 | 37.3 | 24.96 | −95.5551 |
| S12 | Aspheric | −37.7511 | 0.5616 | | | | 0.0000 |
| S13 | Aspheric | 4.7227 | 0.6650 | 1.55 | 56.1 | 8.57 | −9.1927 |
| S14 | Aspheric | −550.0284 | 1.0900 | | | | 2.2121 |
| S15 | Aspheric | −4.8270 | 0.3800 | 1.54 | 55.9 | −4.53 | −2.0396 |
| S16 | Aspheric | 5.0487 | 0.1253 | | | | −0.3531 |
| S17 | Spherical | Infinite | 0.1100 | 1.52 | 64.2 | | |
| S18 | Spherical | Infinite | 0.6490 | | | | |
| S19 | Spherical | Infinite | | | | | |

TABLE 16

| Surface | | | | | |
|---|---|---|---|---|---|
| number | A4 | A6 | A8 | A10 | A12 |
| S1 | 1.9545E−03 | 1.6966E−03 | −2.6795E−03 | 2.8146E−03 | −1.7424E−03 |
| S2 | −5.7806E−03 | 7.5608E−03 | −4.9584E−03 | 1.9152E−03 | −4.3318E−04 |
| S3 | −2.4216E−02 | 1.1343E−02 | −2.2971E−03 | −2.6325E−03 | 3.0154E−03 |
| S4 | −1.6379E−02 | 4.4929E−03 | 6.5137E−03 | −1.1687E−02 | 1.0433E−02 |
| S5 | −2.1042E−03 | −5.9040E−03 | 1.0956E−02 | −1.3452E−02 | 1.1204E−02 |
| S6 | −4.8899E−03 | 7.9265E−03 | −2.2932E−02 | 3.6040E−02 | −3.5382E−02 |
| S7 | −1.8188E−02 | −1.4211E−03 | −2.9331E−03 | 2.4818E−03 | −1.6685E−03 |
| S8 | −1.8053E−02 | −5.8285E−03 | 1.0158E−02 | −1.3065E−02 | 9.5083E−03 |
| S9 | −2.7885E−02 | −3.0230E−03 | 5.6043E−03 | −2.7564E−03 | 6.1175E−04 |
| S10 | −5.3766E−03 | −1.5638E−02 | 1.2126E−02 | −5.1598E−03 | 1.3441E−03 |
| S11 | 7.1672E−03 | −1.9986E−02 | 1.5783E−02 | −8.1870E−03 | 2.8255E−03 |
| S12 | −1.6195E−02 | −5.6100E−03 | 6.2377E−03 | −2.0151E−03 | 2.0716E−05 |
| S13 | 5.0886E−03 | −1.1188E−02 | 4.6450E−03 | −1.9907E−03 | 8.5191E−04 |
| S14 | 2.1652E−02 | −1.5686E−02 | 6.0066E−03 | −2.7761E−03 | 1.1994E−03 |
| S15 | −3.3080E−02 | 8.6666E−03 | −4.1660E−03 | 1.7446E−03 | −4.1327E−04 |
| S16 | −4.4682E−02 | 1.3234E−02 | −4.2832E−03 | 1.1296E−03 | −2.0617E−04 |

| Surface | | | | |
|---|---|---|---|---|
| number | A14 | A16 | A18 | A20 |
| S1 | 6.5650E−04 | −1.4829E−04 | 1.8462E−05 | −9.8282E−07 |
| S2 | 8.0002E−05 | −3.1184E−05 | 1.1165E−05 | −1.9622E−06 |
| S3 | −1.4755E−03 | 3.9808E−04 | −5.7701E−05 | 3.5053E−06 |
| S4 | −5.4599E−03 | 1.7020E−03 | −2.8860E−04 | 2.0235E−05 |
| S5 | −5.8731E−03 | 1.9038E−03 | −3.4411E−04 | 2.6509E−05 |
| S6 | 2.3038E−02 | −9.9421E−03 | 2.7528E−03 | −4.4431E−04 |
| S7 | 6.5906E−04 | −1.3866E−04 | 1.1881E−05 | −1.6621E−07 |
| S8 | −4.2663E−03 | 1.1696E−03 | −1.7937E−04 | 1.1809E−05 |
| S9 | −6.0674E−05 | 3.0936E−06 | −4.4467E−07 | 4.2521E−08 |
| S10 | −2.1729E−04 | 2.1274E−05 | −1.1646E−06 | 2.7662E−08 |
| S11 | −6.4499E−04 | 9.6863E−05 | −9.3114E−06 | 5.2289E−07 |
| S12 | 1.7494E−04 | −5.4907E−05 | 8.0685E−06 | −6.1734E−07 |
| S13 | −2.6964E−04 | 5.7004E−05 | −8.0829E−06 | 7.8255E−07 |
| S14 | −3.5933E−04 | 7.1991E−05 | −9.8730E−06 | 9.4369E−07 |
| S15 | 5.9508E−05 | −5.5044E−06 | 3.2871E−07 | −1.1824E−08 |
| S16 | 2.5350E−05 | −2.0961E−06 | 1.1387E−07 | −3.7047E−09 |

FIG. 16A illustrates a longitudinal aberration curve of the camera lens assembly according to example 8, representing deviations of focal points converged by light of different wavelengths after passing through the lens assembly. FIG. 16B illustrates an astigmatic curve of the camera lens assembly according to example 8, representing a curvature of a tangential plane and a curvature of a sagittal plane. FIG. 16C illustrates a distortion curve of the camera lens assembly according to example 8, representing amounts of distortion corresponding to different image heights. FIG. 16D illustrates a lateral color curve of the camera lens assembly according to example 8, representing deviations of different image heights on an imaging plane after light passes through the lens assembly. It can be seen from FIG. 16A to FIG. 16D that the camera lens assembly provided in example 8 may achieve good image quality.

### Example 9

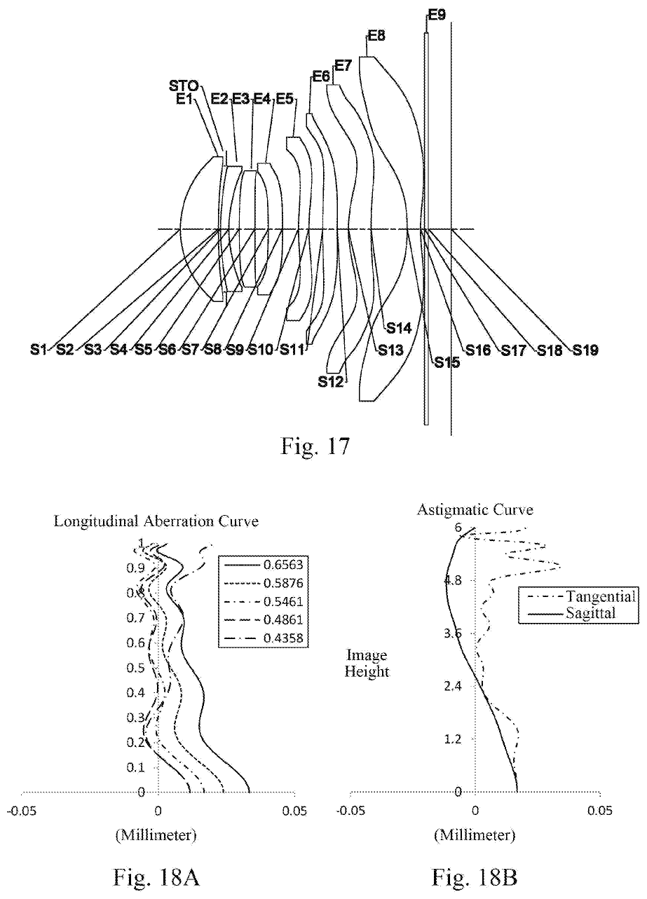

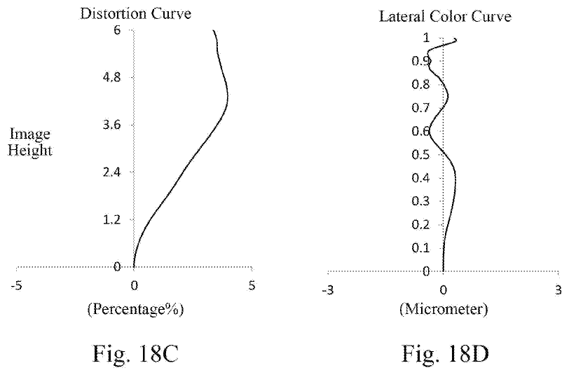

A camera lens assembly according to example 9 of the present disclosure is described below with reference to FIG. 17 to FIG. 18D. FIG. 17 shows a schematic structural view of the camera lens assembly according to example 9 of the present disclosure.

As shown in FIG. 17, the camera lens assembly includes a first lens E1, a stop STO, a second lens E2, a third lens E3, a fourth lens E4, a fifth lens E5, a sixth lens E6, a seventh lens E7, an eighth lens E8, an optical filter E9 and an imaging plane S19, which are sequentially arranged from an object side to an image side.

The first lens E1 has positive refractive power, an object-side surface S1 thereof is convex, and an image-side surface S2 thereof is concave. The second lens E2 has negative refractive power, an object-side surface S3 thereof is convex, and an image-side surface S4 thereof is concave. The third lens E3 has positive refractive power, an object-side surface S5 thereof is convex, and an image-side surface S6 thereof is convex. The fourth lens E4 has negative refractive power, an object-side surface S7 thereof is concave, and an image-side surface S8 thereof is convex. The fifth lens E5 has negative refractive power, an object-side surface S9 thereof is convex, and an image-side surface S10 thereof is concave. The sixth lens E6 has negative refractive power, an object-side surface S11 thereof is convex, and an image-side surface S12 thereof is concave. The seventh lens E7 has positive refractive power, an object-side surface S13 thereof is convex, and an image-side surface S14 thereof is concave. The eighth lens E8 has negative refractive power, an object-side surface S15 thereof is concave, and an image-side surface S16 thereof is concave. The optical filter E9 has an object-side surface S17 and an image-side surface S18. Light from an object sequentially passes through the respective surfaces S1 to S18 and is finally imaged on the imaging plane S19.

In this example, a total effective focal length f of the camera lens assembly is 6.60 mm, a total length TTL of the camera lens assembly is 7.90 mm, half of a diagonal length ImgH of an effective pixel area on the imaging plane S19 of the camera lens assembly is 6.00 mm, half of a maximal field-of-view Semi-FOV of the camera lens assembly is 41.09°, and an aperture value Fno of the camera lens assembly is 1.65.

Table 17 is a table illustrating basic parameters of the camera lens assembly of example 9, wherein the units for the radius of curvature, the thickness/distance and the focal length are millimeter (mm). Table 18 shows high-order coefficients applicable to each aspheric surface in example 9, wherein the surface shape of each aspheric surface may be defined by the formula (1) given in the above example 1.

TABLE 17

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| S1 | Aspheric | 2.7534 | 1.1108 | 1.55 | 56.1 | 5.77 | −0.2604 |
| S2 | Aspheric | 18.6626 | 0.2282 | | | | 24.0674 |
| STO | Spherical | Infinite | −0.1700 | | | | |
| S3 | Aspheric | 6.1148 | 0.2471 | 1.68 | 19.2 | −12.55 | 6.2644 |
| S4 | Aspheric | 3.5027 | 0.3006 | | | | −0.5778 |
| S5 | Aspheric | 21.0945 | 0.4579 | 1.57 | 37.3 | 36.69 | 28.0514 |
| S6 | Aspheric | −3247.2035 | 0.3900 | | | | 99.0000 |
| S7 | Aspheric | −30.2386 | 0.4112 | 1.64 | 23.4 | −136.36 | 91.5808 |
| S8 | Aspheric | −46.4483 | 0.4675 | | | | 14.3346 |
| S9 | Aspheric | 7.1283 | 0.3048 | 1.68 | 19.2 | −59.92 | 0.8651 |
| S10 | Aspheric | 5.9614 | 0.4031 | | | | −14.0800 |
| S11 | Aspheric | 17.5155 | 0.4203 | 1.57 | 37.3 | −122.06 | −99.0000 |
| S12 | Aspheric | 13.8768 | 0.3278 | | | | 1.7451 |
| S13 | Aspheric | 3.2548 | 0.6617 | 1.55 | 56.1 | 6.88 | −0.9974 |
| S14 | Aspheric | 22.5390 | 1.0574 | | | | 26.5775 |
| S15 | Aspheric | −5.4463 | 0.3842 | 1.54 | 55.9 | −4.80 | −3.1532 |
| S16 | Aspheric | 5.0227 | 0.1191 | | | | −0.1687 |
| S17 | Spherical | Infinite | 0.1100 | 1.52 | 64.2 | | |
| S18 | Spherical | Infinite | 0.6690 | | | | |
| S19 | Spherical | Infinite | | | | | |

TABLE 18

| Surface | | | | | |
|---|---|---|---|---|---|
| number | A4 | A6 | A8 | A10 | A12 |
| S1 | 2.9082E−03 | −2.0086E−03 | 3.1981E−03 | −2.5144E−03 | 1.1901E−03 |
| S2 | 5.4651E−03 | −1.2414E−02 | 1.8395E−02 | −1.7336E−02 | 1.1318E−02 |
| S3 | −1.3107E−02 | −1.5651E−02 | 2.3960E−02 | −1.9543E−02 | 1.0488E−02 |
| S4 | −1.0833E−02 | −2.0215E−03 | 6.4823E−04 | 4.4425E−03 | −5.7818E−03 |
| S5 | 8.2004E−03 | −8.4966E−03 | 1.3936E−02 | −1.6636E−02 | 1.2580E−02 |
| S6 | 1.1555E−03 | −3.2206E−04 | 5.4182E−03 | −1.5553E−02 | 2.1761E−02 |
| S7 | −2.4030E−02 | 3.1106E−03 | −1.0939E−02 | 1.1010E−02 | −7.0366E−03 |
| S8 | −2.1116E−02 | −5.1525E−03 | 9.9728E−03 | −1.3988E−02 | 1.1123E−02 |
| S9 | −2.6593E−02 | 1.5630E−03 | −1.7520E−04 | 4.4768E−04 | −3.2154E−04 |
| S10 | −1.6629E−02 | 2.0584E−03 | −2.2095E−03 | 1.7191E−03 | −7.3917E−04 |
| S11 | −1.7937E−02 | 1.8790E−02 | −1.1673E−02 | 4.7145E−03 | −1.3891E−03 |
| S12 | −6.3320E−02 | 3.9100E−02 | −2.0995E−02 | 9.8239E−03 | −3.6599E−03 |
| S13 | −2.9968E−02 | 3.8269E−03 | 1.3441E−03 | −2.8156E−03 | 1.6921E−03 |
| S14 | 2.6432E−02 | −1.7845E−02 | 8.8170E−03 | −4.9403E−03 | 2.1131E−03 |
| S15 | −3.2781E−02 | 1.0830E−02 | −2.5730E−03 | −1.0324E−04 | 2.7071E−04 |
| S16 | −4.6871E−02 | 1.6202E−02 | −5.2152E−03 | 1.2009E−03 | −1.8761E−04 |

| Surface | | | | |
|---|---|---|---|---|
| number | A14 | A16 | A18 | A20 |
| S1 | −3.3525E−04 | 5.3102E−05 | −3.9718E−06 | 6.5508E−08 |
| S2 | −5.1216E−03 | 1.5598E−03 | −3.0285E−04 | 3.3674E−05 |
| S3 | −3.7314E−03 | 8.4511E−04 | −1.1016E−04 | 6.2768E−06 |
| S4 | 3.6140E−03 | −1.2882E−03 | 2.5719E−04 | −2.2296E−05 |
| S5 | −5.7939E−03 | 1.5842E−03 | −2.2603E−04 | 1.2310E−05 |
| S6 | −1.7379E−02 | 8.4254E−03 | −2.4406E−03 | 3.8798E−04 |
| S7 | 2.5795E−03 | −4.5793E−04 | 1.0668E−05 | 5.1530E−06 |
| S8 | −5.3992E−03 | 1.5864E−03 | −2.5972E−04 | 1.8317E−05 |
| S9 | 8.4294E−05 | −8.1602E−06 | −2.3766E−07 | 6.5379E−08 |
| S10 | 1.8559E−04 | −2.7483E−05 | 2.2220E−06 | −7.5260E−08 |
| S11 | 2.8814E−04 | −3.9755E−05 | 3.4080E−06 | −1.6209E−07 |
| S12 | 9.9346E−04 | −1.9119E−04 | 2.5946E−05 | −2.4575E−06 |
| S13 | −5.6369E−04 | 1.1837E−04 | −1.6545E−05 | 1.5787E−06 |
| S14 | −6.1213E−04 | 1.2133E−04 | −1.6804E−05 | 1.6429E−06 |
| S15 | −8.1023E−05 | 1.3043E−05 | −1.3435E−06 | 9.3861E−08 |
| S16 | 1.9808E−05 | −1.3832E−06 | 5.7818E−08 | −7.7835E−10 |

FIG. 18A illustrates a longitudinal aberration curve of the camera lens assembly according to example 9, representing deviations of focal points converged by light of different wavelengths after passing through the lens assembly. FIG. 18B illustrates an astigmatic curve of the camera lens assembly according to example 9, representing a curvature of a tangential plane and a curvature of a sagittal plane. FIG. 18C illustrates a distortion curve of the camera lens assembly according to example 9, representing amounts of distortion corresponding to different image heights. FIG. 18D illustrates a lateral color curve of the camera lens assembly according to example 9, representing deviations of different image heights on an imaging plane after light passes through the lens assembly. It can be seen from FIG. 18A to FIG. 18D that the camera lens assembly provided in example 9 may achieve good image quality.

In view of the above, examples 1 to 9 respectively satisfy the relationship shown in Table 19.

TABLE 19

| | Example | | | | | | | | |
|---|---|---|---|---|---|---|---|---|---|
| Condition | 1 | 2 | 3 | 4 | 5 | 6 | 7 | 8 | 9 |
| f/tan²(Semi-FOV) | 8.20 | 8.54 | 8.89 | 8.26 | 8.39 | 8.16 | 8.65 | 8.63 | 8.69 |
| TTL/ImgH | 1.26 | 1.29 | 1.31 | 1.27 | 1.26 | 1.26 | 1.31 | 1.31 | 1.317 |
| ImgH | 6.26 | 6.10 | 6.02 | 6.22 | 6.22 | 6.22 | 6.02 | 6.02 | 6.00 |
| R5/f | 1.37 | 1.47 | 1.28 | 1.23 | 1.36 | 1.37 | 1.17 | 1.20 | 3.19 |
| CT1/T12 | 28.18 | 15.17 | 14.66 | 22.76 | 18.10 | 17.45 | 13.76 | 21.02 | 19.08 |
| (R2 + R3)/(R2 − R3) | 2.28 | 2.13 | 2.12 | 2.10 | 2.17 | 2.25 | 2.22 | 2.25 | 1.97 |
| f67/BFL | 10.75 | 10.44 | 10.96 | 13.45 | 11.26 | 10.38 | 8.96 | 7.38 | 8.17 |
| SAG11/SAG12 | 8.26 | 8.63 | 8.43 | 9.43 | 8.50 | 8.39 | 8.26 | 8.39 | 7.73 |
| (DT82 + DT11)/ | 2.55 | 2.50 | 2.56 | 2.63 | 2.50 | 2.59 | 2.48 | 2.42 | 2.45 |
| (DT82 − DT11) | | | | | | | | | |
| ET8/ET7 | 2.30 | 2.42 | 2.14 | 2.27 | 2.39 | 1.93 | 2.61 | 2.46 | 1.21 |
| f78/f23 | 0.98 | 1.26 | 1.57 | 0.93 | 1.07 | 1.10 | 2.27 | 1.00 | 4.35 |

The present disclosure further provides an imaging apparatus, having an electronic photosensitive element which may be a photosensitive Charge-Coupled Device (CCD) or a Complementary Metal-Oxide Semiconductor (CMOS). The imaging apparatus may be an independent imaging device such as a digital camera, or may be an imaging module integrated in a mobile electronic device such as a mobile phone. The imaging apparatus is equipped with the camera lens assembly described above.

The foregoing is only a description of the preferred examples of the present disclosure and the applied technical principles. It should be appreciated by those skilled in the art that the inventive scope of the present disclosure is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present disclosure with (but not limited to), technical features with similar functions.

What is claimed is:

1. A camera lens assembly, sequentially from an object side to an image side of the camera lens assembly along an optical axis, comprising:
a first lens having positive refractive power;
a second lens having negative refractive power;
a third lens having refractive power;
a fourth lens having refractive power;
a fifth lens having refractive power;
a sixth lens having refractive power;
a seventh lens having positive refractive power; and
an eighth lens having negative refractive power,
wherein 7.00<f67/BFL<14.00,
where f67 is a combined focal length of the sixth lens and the seventh lens, and BFL is a distance along the optical axis from an image-side surface of the eighth lens to an imaging plane of the camera lens assembly.

2. The camera lens assembly according to claim 1, wherein 6.00 mm≤ImgH,
where ImgH is half of a diagonal length of an effective pixel area on the imaging plane of the camera lens assembly.

3. The camera lens assembly according to claim 1, wherein 8.00 mm<f/tan²(Semi-FOV)<9.00 mm,
where f is a total effective focal length of the camera lens assembly, and Semi-FOV is half of a maximal field-of-view of the camera lens assembly.

4. The camera lens assembly according to claim 1, wherein TTL/ImgH<1.32,
where TTL is a distance along the optical axis from an object-side surface of the first lens to the imaging plane of the camera lens assembly, and ImgH is half of a diagonal length of an effective pixel area on the imaging plane of the camera lens assembly.

5. The camera lens assembly according to claim 1, wherein 1.00<R5/f<3.50,
where f is a total effective focal length of the camera lens assembly, and R5 is a radius of curvature of an object-side surface of the third lens.

6. The camera lens assembly according to claim 1, wherein 13.00<CT1/T12<30.00,
where T12 is a spaced interval between the first lens and the second lens along the optical axis, and CT1 is a center thickness of the first lens along the optical axis.

7. The camera lens assembly according to claim 1, wherein 1.50<(R2+R3)/(R2−R3)<2.50,
where R2 is a radius of curvature of an image-side surface of the first lens, and R3 is a radius of curvature of an object-side surface of the second lens.

8. The camera lens assembly according to claim 1, wherein 7.00<SAG11/SAG12<10.00,
where SAG11 is a distance along the optical axis from an intersection of an object-side surface of the first lens and the optical axis to a vertex of an effective radius of the object-side surface of the first lens, and SAG12 is a distance along the optical axis from an intersection of an image-side surface of the first lens and the optical axis to a vertex of an effective radius of the image-side surface of the first lens.

9. The camera lens assembly according to claim 1, wherein 2.00<(DT82+DT11)/(DT82−DT11)<3.00,
where DT82 is a maximum effective radius of the image-side surface of the eighth lens, and DT11 is a maximum effective radius of an object-side surface of the first lens.

10. The camera lens assembly according to claim 1, wherein 1.00<ET8/ET7<3.00,
where ET7 is an edge thickness of the seventh lens, and ET8 is an edge thickness of the eighth lens.

11. The camera lens assembly according to claim 1, wherein 0.50<f78/f23<4.50,
where f23 is a combined focal length of the second lens and the third lens, and f78 is a combined focal length of the seventh lens and the eighth lens.

12. A camera lens assembly, sequentially from an object side to an image side of the camera lens assembly along an optical axis, comprising:
a first lens having positive refractive power;
a second lens having negative refractive power;
a third lens having refractive power;
a fourth lens having refractive power;
a fifth lens having refractive power;
a sixth lens having refractive power;
a seventh lens having positive refractive power; and
an eighth lens having negative refractive power,
wherein 0.50<f78/f23<4.50,
where f23 is a combined focal length of the second lens and the third lens, and f78 is a combined focal length of the seventh lens and the eighth lens.

13. The camera lens assembly according to claim 12, wherein 6.00 mm≤ImgH,
where ImgH is half of a diagonal length of an effective pixel area on an imaging plane of the camera lens assembly.

14. The camera lens assembly according to claim 12, wherein 8.00 mm<f/tan²(Semi-FOV)<9.00 mm,
where f is a total effective focal length of the camera lens assembly, and Semi-FOV is half of a maximal field-of-view of the camera lens assembly.

15. The camera lens assembly according to claim 12, wherein TTL/ImgH<1.32,
where TTL is a distance along the optical axis from an object-side surface of the first lens to an imaging plane of the camera lens assembly, and ImgH is half of a diagonal length of an effective pixel area on the imaging plane of the camera lens assembly.

16. The camera lens assembly according to claim 12, wherein 1.00<R5/f<3.50,
where f is a total effective focal length of the camera lens assembly, and R5 is a radius of curvature of an object-side surface of the third lens.

17. The camera lens assembly according to claim 12, wherein 13.00<CT1/T12<30.00,
where T12 is a spaced interval between the first lens and the second lens along the optical axis, and CT1 is a center thickness of the first lens along the optical axis.

18. The camera lens assembly according to claim 12, wherein 1.50<(R2+R3)/(R2−R3)<2.50,
where R2 is a radius of curvature of an image-side surface of the first lens, and R3 is a radius of curvature of an object-side surface of the second lens.

19. The camera lens assembly according to claim 12, wherein 7.00<SAG11/SAG12<10.00,
where SAG11 is a distance along the optical axis from an intersection of an object-side surface of the first lens and the optical axis to a vertex of an effective radius of the object-side surface of the first lens, and SAG12 is a distance along the optical axis from an intersection of an image-side surface of the first lens and the optical axis to a vertex of an effective radius of the image-side surface of the first lens.

20. The camera lens assembly according to claim 12, wherein 2.00<(DT82+DT11)/(DT82−DT11)<3.00,
where DT82 is a maximum effective radius of an image-side surface of the eighth lens, and DT11 is a maximum effective radius of an object-side surface of the first lens.
